(19) United States
(12) Patent Application Publication
(10) Pub. No.: US 2022/0196543 A1
(43) Pub. Date: Jun. 23, 2022

(54) SAMPLE STRUCTURE MEASURING DEVICE AND SAMPLE STRUCTURE MEASURING METHOD

(71) Applicant: OLYMPUS CORPORATION, Tokyo (JP)

(72) Inventor: Mayumi ODAIRA, Tokyo (JP)

(73) Assignee: OLYMPUS CORPORATION, Tokyo (JP)

(21) Appl. No.: 17/687,938

(22) Filed: Mar. 7, 2022

Related U.S. Application Data
(63) Continuation of application No. PCT/JP2019/048773, filed on Dec. 12, 2019.

(51) Int. Cl. G01N 21/03

(52) U.S. Cl. CPC G01N 21/0303; G01N 21/59

(57) ABSTRACT

A sample structure measuring device includes a light source, a path splitting portion configured to split light from the light source into light on a measurement path passing through a sample and light on a reference path, an optical path merging portion configured to merge the measurement path and the reference path, a photodetector having pixels and configured to detect incident light from the path merging portion and output phase data of the incident light, and a processor. A first region is a region where the sample is present and a second region is a region where the sample is not present. The processor divides the phase data into the first region and the second region, sets an initial estimated sample structure based on the first region, and optimizes the estimated sample structure using simulated light transmitted through the estimated sample structure and measurement light transmitted through the sample.

### CROSS REFERENCES

The present application is a continuation application of International Application No. PCT/JP2019/048773 filed on Dec. 12, 2019, the entire contents of which are incorporated herein by reference.

### BACKGROUND OF INVENTION

### Technical Field

The present disclosure relates to a sample structure measuring device and a sample structure measuring method.

### Description of the Related Art

A device that measures a refractive index distribution of a sample using interference is disclosed in Japanese Patent Application Laid-open No. H11-230833. In this device, a plurality of interference patterns and Inverse Radon transform are used.

FIG. 20 is a diagram illustrating a sample. A sample S1 is a colorless transparent sphere. The diameter of the sphere is 20 μm. The size of the sample S1 is substantially equal to the size of one cell. Therefore, a description is given assuming that the sample S1 is considered as one cell.

It is assumed that the interior of the cell is homogeneous and the surroundings of the cell are filled with liquid. In FIG. 20, the interior of the sphere is filled with a medium with a refractive index of 1.36, and the surroundings of the sphere are filled with water with a refractive index of 1.33.

Light emitted from a light source (not illustrated) is split into measurement light Lₘ and reference light L_{ref}. The measurement light Lₘ and the reference light L_{ref} are plane waves. The wavelength of the measurement light Lₘ and the wavelength of the reference light L_{ref} are 0.633 μm. The measurement light Lₘ travels through a measurement optical path, and the reference light L_{ref} travels through a reference optical path.

The sample S1 is disposed on the measurement optical path. The sample S1 is irradiated with the measurement light Lₘ. Measurement light Lₘ′ is emanated from the sample S1. The measurement light Lₘ′ is incident together with the reference light L_{ref} on a photodetector D. An interference pattern is formed on a light-receiving surface of the photodetector D.

A range wider than a circle having a diameter of 20 μm is irradiated with the measurement light Lₘ. Therefore, a place where the sample S1 is present and a place where the sample S1 is not present are irradiated with the measurement light Lₘ. In this case, the interference pattern includes a first interference pattern and a second interference pattern.

The first interference pattern is an interference pattern formed by measurement light passing through the sample. The second interference pattern is an interference pattern formed by measurement light not passing through the sample.

FIG. 21A, FIG. 21B, FIG. 21C, FIG. 21D, FIG. 21E, and FIG. 21F are diagrams illustrating a phase. FIG. 21A and FIG. 21B are diagrams illustrating a phase of a plane wave. FIG. 21C and FIG. 21D are diagrams illustrating a wrapped phase. FIG. 21E and FIG. 21F are diagrams illustrating a unwrapped phase. FIG. 21B, FIG. 21D, and FIG. 21F are enlarged diagrams.

The wrapped phase is the phase of electric field subjected to wrapping. The unwrapped phase is the phase of electric field subjected to unwrapping. Wrapping and unwrapping will be described later.

As described above, the place where the sample S1 is present and the place where the sample S1 is not present are irradiated with the measurement light Lₘ. Thus, the measurement light Lₘ′ includes light from a region A1 and light from a region A2.

A sphere is present in the region A1. A sphere is not present in the region A2. Therefore, as illustrated in FIG. 21A and FIG. 21B, a phase lag occurs in light from the region A1, and no phase lag occurs in light from the region A2.

It is possible to calculate the phase lag by summing the optical path lengths substantially in the optical axis direction. In a sphere, the thickness increases from the periphery toward the center. That is, the optical path length increases from the periphery toward the center. Therefore, as illustrated in FIG. 21A and FIG. 21B, the phase lag increases from the periphery toward the center.

The maximum value Amax of the phase lag is represented by the following Expression:

Δmax=2π×d×Δn/λ

where

d is the maximum thickness of the thicknesses of the sample,

the thickness of the sample is a thickness in a direction parallel to the optical axis,

Δn is the difference between the refractive index of the region A1 and the refractive index of the region A2, and

λ is the wavelength of light irradiating the sample.

In the sample S1, d=20 μm, Δn=0.03, λ=0.633 μm, and therefore Δmax=6.0.

In the photodetector D, an interference pattern is detected. The interference pattern includes phase information of the plane wave. Therefore, it is possible to calculate the phase information of the plane wave from the interference pattern. It is noted that the phase calculated from the interference pattern is the phase of electric field.

In some cases, a phase replacement occurs in the detected phase of electric field. The phase replacement occurs when the phase of electric field is smaller than −π and when the phase of electric field is larger than +π. In either case, the phase of electric field is replaced by the phase in a range from −π to +π. Here, this phase replacement is called wrapping.

In the sample S1, the phase of a region larger than +π in the phase of electric field is wrapped. As a result, as illustrated in FIG. 21C and FIG. 21D, the phase larger than +π is replaced by the phase from −π to +π.

As described above, it is possible to calculate the refractive index distribution of the sample by using a plurality of interference patterns and Inverse Radon transform. Since the phase of electric field is obtained from the interference pattern, it is possible to calculate the shape of the sample, the size of the sample, and the refractive index distribution in the sample by using the phase of electric field and Inverse Radon transform.

When the phase of electric field obtained from the interference pattern is not wrapped, it is possible to use the obtained phase of electric field as it is. On the other hand, when the phase of electric field obtained from the interference pattern is wrapped, it is not possible to use the obtained phase of electric field as it is.

As illustrated in FIG. 21C and FIG. 21D, in the wrapped phase, the phase is not smooth. Thus, if the wrapped phase is used, it is not possible to accurately calculate the shape of the sample S1 and the size of the sample S1.

Then, unwrapping, that is, continuity of phase is performed. In unwrapping, calculation is performed using adjacent two pixels. Specifically, calculation is performed such that, with respect to the phase in one pixel, the phase in the other pixel is equal to or smaller than n.

By performing unwrapping, it is possible to smoothly make it continuous non-smooth phase. As a result, as illustrated in FIG. 21E and FIG. 21F, in the unwrapped phase, the phase is smoothly continuous.

As can be understood from the comparison between FIG. 21A and FIG. 21E or the comparison between FIG. 21B and FIG. 21F, the unwrapped phase matches the phase of the plane wave. Therefore, by using the unwrapped phase, it is possible to accurately calculate the shape of the sample S1 and the size of the sample S1.

Furthermore, in Inverse Radon transform, it is possible to correctly obtain the refractive index distribution of the sample when the measurement light incident on the photodetector is parallel light. Since the interior of the sample S1 is homogeneous, parallel light is incident on the photodetector D. Furthermore, the shape of the sample S1 and the size of the sample S1 are calculated accurately. Therefore, it is possible to accurately calculate the refractive index distribution of the sample S1 by using Inverse Radon transform.

The size of the sample S1 is substantially the same as the size of one cell. As described above, by using the unwrapped phase, it is possible to accurately calculate the shape of the sample S1 and the size of the sample S1. Thus, in one cell, it is possible to accurately calculate the shape of the cell and the size of the cell by using the unwrapped phase.

Furthermore, by using Inverse Radon transform, it is possible to accurately calculate the refractive index distribution of the sample S1. Thus, when the interior of the cell can be considered as being homogeneous, it is possible to accurately calculate the refractive index distribution of the cell by using Inverse Radon transform.

However, in a cell having a nucleus, the refractive index of the nucleus differs from the refractive index of the cytoplasm and therefore the interior of the cell is not homogeneous. In this case, the measurement light is refracted, diffracted, or scattered by the cell. As a result, converging light or diverging light is incident on the photodetector.

As described above, in Inverse Radon transform, it is possible to accurately calculate the refractive index distribution when the measurement light incident on the photodetector is parallel light. Thus, if the measurement light incident on the photodetector is converging light or diverging light, it is not possible to accurately calculate the refractive index distribution. That is, when the interior of the cell is not homogeneous, it is not possible to accurately calculate the refractive index distribution of the cell even by using Inverse Radon transform.

A device that measures the refractive index distribution of a sample is disclosed in Ulugbek S. Kamilov et al., “Learning approach to optical tomography”, Optica, June 2015, Vol. 2, No. 6, 517-522. In this device, optimization of the refractive index distribution is performed.

In this device, a plurality of interference patterns and Inverse Radon transform are also used. Therefore, even when the sample is one cell, it is possible to accurately calculate the shape of the cell and the size of the cell. However, as described above, when the interior of the cell is not homogeneous, it is not possible to accurately calculate the refractive index distribution of the cell, merely by using Inverse Radon transform.

Then, in this device, optimization of the refractive index distribution is performed in order to accurately calculate the refractive index distribution of the sample. In the optimization, the refractive index distribution calculated by Inverse Radon transform is set as an initial value.

Furthermore, in the optimization, a cost function is used. The cost function is represented by the difference or the ratio between a measured value of measurement light and an estimation value by simulation.

The measured value of measurement light is calculated from an optical image of the sample. Therefore, the measured value of measurement light indirectly includes information of the refractive index distribution of the sample. The estimation value by simulation is calculated based on the refractive index distribution of a model sample.

When the refractive index distribution in the model sample is changed, the value of the cost function changes. When the difference is used as the cost function, the refractive index distribution in the model sample approaches the refractive index distribution of the sample as the value of the cost function decreases.

When the value of the cost function becomes equal to or smaller than a threshold value, the refractive index distribution in the model sample matches the refractive index distribution of the sample or substantially matches the refractive index distribution of the sample. As a result, it is possible to accurately calculate the refractive index distribution of the sample. That is, even when the sample is one cell and the interior of the cell is not homogeneous, it is possible to accurately calculate the refractive index distribution of the cell.

FIG. 22 is a diagram illustrating a sample. A sample S2 is a colorless transparent sphere. The diameter of the sphere is 500 μm. The size of the sample S2 is substantially equal to the size of an aggregation of a plurality of cells. Therefore, a description is given assuming that the sample S2 is considered as the aggregation of a plurality of cells.

It is assumed that the interior of the aggregation is homogeneous and the surroundings of the aggregation are filled with liquid. In FIG. 22, the interior of the sphere is filled with a medium with a refractive index of 1.36, and the surroundings of the sphere are filled with water with a refractive index of 1.33.

The sample S2 is disposed on the measurement optical path. The sample S2 is irradiated with measurement light Lₘ. Measurement light Lₘ′ is emanated from the sample S2. The measurement light Lₘ′ is incident together with reference light L_{ref} on a photodetector D. An interference pattern is formed on a light-receiving surface of the photodetector D.

A range wider than a circle having a diameter of 500 μm is irradiated with the measurement light Lₘ. Therefore, a place where the sample S2 is present and a place where the sample S2 is not present are irradiated with the measurement light Lₘ.

FIG. 23A, FIG. 23B, FIG. 23C, FIG. 23D, FIG. 23E, and FIG. 23F are diagrams illustrating a phase. FIG. 23A and FIG. 23B are diagrams illustrating a phase of a plane wave. FIG. 23C and FIG. 23D are diagrams illustrating a wrapped phase. FIG. 23E and FIG. 23F are diagrams illustrating a unwrapped phase. FIG. 23B, FIG. 23D, and FIG. 23F are enlarged diagrams.

As described above, the place where the sample S2 is present and the place where the sample S2 is not present are irradiated with the measurement light Lₘ. Thus, the measurement light Lₘ′ incident on the photodetector D includes light from a region A1 and light from a region A2.

A sphere is present in the region A1. A sphere is not present in the region A2. Therefore, as illustrated in FIG. 23A and FIG. 23B, a phase lag occurs in light from the region A1, and no phase lag occurs in light from the region A2.

In the sample S2, d=500 μm, Δn=0.03, λ=0.633 μm, and therefore Δmax=148.8.

In the sample S2, the phase of electric field corresponding to π is 3.0. Thus, in the phase of electric field, the phase of a region larger than 3.0 is wrapped. As a result, as illustrated in FIG. 23C and FIG. 23D, the phase larger than 3.0 is replaced by the phase from −π to +π.

The phase significantly changes at the boundary between the region A1 and the region A2. The diameter of the sample S2 is larger than the diameter of the sample S1. Thus, in the sample S2, the phase changes much more significantly at the boundary between the region A1 and the region A2 than in the sample S1.

In this case, it is not possible to smoothly connect the non-smooth phase even by performing unwrapping. As a result, as illustrated in FIG. 23E and FIG. 23F, in the unwrapped phase, the phase is not smoothly connected.

As can be understood from the comparison between FIG. 23A and FIG. 23E or the comparison between FIG. 23B and FIG. 23F, the unwrapped phase does not match the phase of the plane wave. Therefore, even by using the unwrapped phase, it is not possible to accurately calculate the shape of the sample S2 and the size of the sample S2.

Since the interior of the sample S2 is homogeneous, parallel light is incident on the photodetector D. However, the shape of the sample S2 and the size of the sample S2 are not calculated accurately. Thus, even by using Inverse Radon transform, it is not possible to accurately calculate the refractive index distribution of the sample S2.

The size of the sample S2 is larger than the size of the sample S1. As described above, the size of the sample S1 is substantially the same as the size of one cell. Therefore, the size of the sample S2 is substantially the same as the size of the aggregation of a plurality of cells, for example, the size of a spheroid.

As described above, in the sample S2, even by using the unwrapped phase, it is not possible to accurately calculate the shape of the sample S2 and the size of the sample S2. Thus, in the spheroid, even by using the unwrapped phase, it is not possible to accurately calculate the shape of the spheroid and the size of the spheroid.

The spheroid is the aggregation of a plurality of cells. When each cell includes a nucleus, the spheroid includes a plurality of nuclei. The refractive index of the nucleus is different from the refractive index of the cytoplasm. As just described, the spheroid has a plurality of minute regions with different refractive indices.

Thus, the interior of the spheroid is not homogeneous. In this case, the measurement light is refracted, diffracted, or scattered by the spheroid. As a result, converging light or diverging light is incident on the photodetector.

As described above, if the measurement light incident on the photodetector is converging light or diverging light, it is not possible to accurately calculate the refractive index distribution. Therefore, in calculation of the refractive index distribution of the spheroid, the refractive index distribution is calculated using Inverse Radon transform, the calculated refractive index distribution is set as an initial value, and optimization of the refractive index distribution is performed.

In the optimization, an estimation value by simulation is used. In calculation of the estimation value by simulation, a model sample is used. In order to calculate the estimation value, it is necessary that the shape of the model sample and the size of the model sample be calculated accurately.

However, as described above, it is not possible to accurately calculate the shape of the spheroid and the size of the spheroid. Thus, it is not possible to accurately set the shape of the model sample and the size of the model sample.

Furthermore, since it is not possible to set the shape of the model sample and the size of the model sample, it is not possible to perform optimization of the refractive index distribution. As a result, it is not possible to accurately calculate the refractive index distribution of the spheroid.

FIG. 24 is a diagram illustrating a sample. A sample S3 is a photonic crystal fiber (hereinafter referred to as “PCF”). The PCF includes a cylindrical member and through holes.

In the PCF, a plurality of through holes are formed in the interior of the cylindrical member. The through holes have a tubular shape and are formed along the generatrix of the cylindrical member. The outer diameter of the PCF is 230 μm and the refractive index of the medium is 1.47. The through holes and surroundings of the cylindrical member are filled with a liquid with a refractive index of 1.44.

The sample S3 is disposed on the measurement optical path. The sample S3 is irradiated with measurement light Lₘ. Measurement light Lₘ′ is emanated from the sample S3. The measurement light Lₘ′ is incident together with reference light L_{ref} on a photodetector D. An interference pattern is formed on a light-receiving surface of the photodetector D.

A range wider than a circle having a diameter of 230 μm is irradiated with the measurement light Lₘ. Therefore, a place where the sample S3 is present and a place where the sample S3 is not present are irradiated with the measurement light Lₘ.

FIG. 25A and FIG. 25B are diagrams illustrating a phase. FIG. 25A is a diagram illustrating a wrapped phase. FIG. 25B is a diagram illustrating a unwrapped phase.

In the sample S3, d=230 μm, Δn=0.03, λ=1.550 μm, and therefore Δmax=27.9.

The phase significantly changes at the boundary between the place where the sample S3 is present and the place where the sample S3 is not present. The diameter of the sample S3 is larger than the diameter of the sample S1. Thus, in the sample S3, the phase changes much more significantly at the boundary between the place where the sample S3 is present and the place where the sample S3 is not present than in the sample S1.

In this case, it is not possible to smoothly connect the non-smooth phase even by performing unwrapping. As a result, as illustrated in FIG. 25B, in the unwrapped phase, the phase is not smoothly connected.

Although the phase of a plane wave is not illustrated, the unwrapped phase does not match the phase of the plane wave. Therefore, even by using the unwrapped phase, it is not possible to accurately calculate the shape of the sample S3 and the size of the sample S3.

In the sample S3, the refractive index of the through holes is different from the refractive index of the cylindrical member. Therefore, the sample S3 has a plurality of minute regions with different refractive indices. Thus, the interior of the sample S3 is not homogeneous.

In this case, the measurement light is refracted, diffracted, or scattered by the sample S3. As a result, converging light or diverging light is incident on the photodetector.

As described above, if the measurement light incident on the photodetector is converging light or diverging light, it is not possible to accurately calculate the refractive index distribution. Therefore, in calculation of the refractive index distribution of the sample S3, the refractive index distribution is calculated using Inverse Radon transform, the calculated refractive index distribution is set as an initial value, and optimization of the refractive index distribution is performed.

In the optimization, an estimation value by simulation is used. In calculation of the estimation value by simulation, a model sample is used. In order to calculate the estimation value, it is necessary that the shape of the model sample and the size of the model sample be calculated accurately.

However, as described above, it is not possible to accurately calculate the shape of the sample S3 and the size of the sample S3. Thus, it is not possible to accurately set the shape of the model sample and the size of the model sample.

Furthermore, since it is not possible to set the shape of the model sample and the size of the model sample, it is not possible to perform optimization of the refractive index distribution. Thus, it is not possible to accurately calculate the refractive index distribution of the sample S3.

As just described, in the sample S3, it is not possible to accurately calculate the shape of the sample S3, the size of the sample S3, and the refractive index distribution of the sample S3. Thus, it is not possible to accurately calculate the shape of the PCF, the size of the PCF, and the refractive index distribution of the PCF.

### SUMMARY

A sample structure measuring device according to at least some embodiments of the present disclosure includes:

a light source;

an optical path splitting portion configured to split light from the light source into light on a measurement optical path passing through a sample and light on a reference optical path;

an optical path merging portion configured to merge light on the measurement optical path and light on the reference optical path;

a photodetector having a plurality of pixels and configured to detect incident light from the optical path merging portion and output phase data of the incident light; and

a processor,

wherein

a first region is a region where the sample is present and a second region is a region where the sample is not present, and

the processor
divides the phase data into phase data of the first region and phase data of the second region,
sets an initial structure of an estimation sample structure based on the phase data of the first region, and
optimizes the estimation sample structure using simulated light transmitted through the estimation sample structure and measurement light transmitted through the sample.

Furthermore, a sample structure measuring method according to at least some embodiments of the present disclosure includes:

splitting light from a light source into light on a measurement optical path passing through a sample and light on a reference optical path;

merging the light on the measurement optical path and the light on the reference optical path; and

detecting incident light from an optical path merging portion by a photodetector having a plurality of pixels and outputting phase data of the incident light,

wherein

a first region is a region where the sample is present and a second region is a region where the sample is not present,

the phase data is divided into phase data of the first region and phase data of the second region,

an initial structure of an estimation sample structure is set based on the phase data of the first region, and

the estimation sample structure is optimized using a cost function including a difference or a ratio between simulated light transmitted through the estimation sample structure and measurement light transmitted through the sample.

### BRIEF DESCRIPTION OF THE DRAWINGS

FIG. 1 is a diagram illustrating a sample structure measuring device of the present embodiment;

FIG. 2A and FIG. 2B are diagrams illustrating an interference pattern and a wrapped phase;

FIG. 3 is a flowchart of a first calculation method;

FIG. 4 is a flowchart at step S10;

FIG. 5A and FIG. 5B are diagrams illustrating one-dimensional phase data and an evaluation value;

FIG. 6A and FIG. 6B are diagrams illustrating a first region and a second region;

FIG. 7A, FIG. 7B, and FIG. 7C are diagrams illustrating a measurement image and an estimation image;

FIG. 8 is a diagram illustrating a wrapped one-dimensional phase data;

FIG. 9 is a diagram illustrating a sample structure measuring device of the present embodiment;

FIG. 10 is a diagram illustrating a sample structure measuring device of the present embodiment;

FIG. 11 is a diagram illustrating a sample structure measuring device of the present embodiment;

FIG. 12 is a flowchart of a second calculation method;

FIG. 13A, FIG. 13B, FIG. 13C, FIG. 13D, FIG. 13E, FIG. 13F, FIG. 13G, FIG. 13H, FIG. 13I, FIG. 13J, FIG. 13K, FIG. 13L, FIG. 13M, FIG. 13N, FIG. 13O, and FIG. 13P are diagrams illustrating irradiation states, planar data, appearance of projection, and solid data;

FIG. 14A, FIG. 14B, FIG. 14C, FIG. 14D, FIG. 14E, FIG. 14F, FIG. 14G, FIG. 14H, FIG. 14I, FIG. 14J, FIG. 14K, and FIG. 14L are diagrams illustrating irradiation states and updating of structure data;

FIG. 15A, FIG. 15B, FIG. 15C, FIG. 15D, FIG. 15E, FIG. 15F, FIG. 15G, FIG. 15H, and FIG. 15I are diagrams illustrating correct shapes and shapes by simulation;

FIG. 16A, FIG. 16B, FIG. 16C, and FIG. 16D are diagrams illustrating an estimation sample structure calculated by the second calculation method;

FIG. 17 is a flowchart of a third calculation method;

FIG. 18A, FIG. 18B, and FIG. 18C are diagrams illustrating an estimation sample structure and a constraint region;

FIG. 19 is a diagram illustrating a sample structure measuring device of the present embodiment;

FIG. 20 is a diagram illustrating a sample;

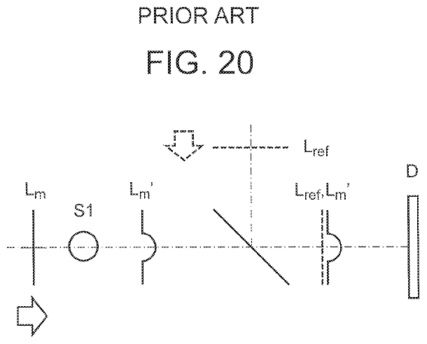

FIG. 21A, FIG. 21B, FIG. 21C, FIG. 21D, FIG. 21E, and FIG. 21F are diagrams illustrating a phase;

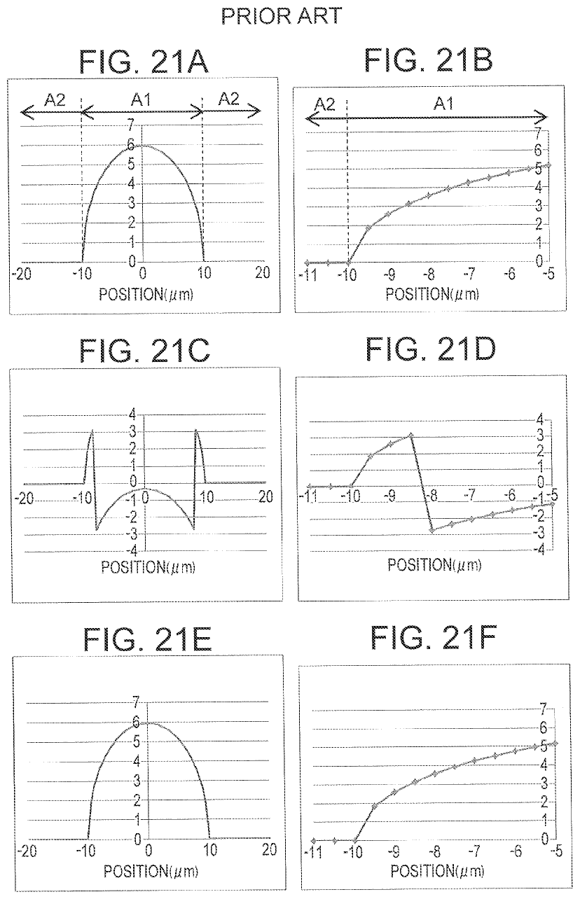

FIG. 22 is a diagram illustrating a sample;

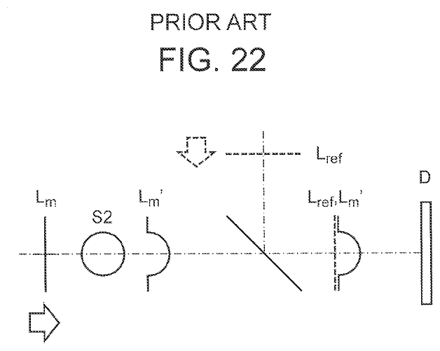

FIG. 23A, FIG. 23B, FIG. 23C, FIG. 23D, FIG. 23E, and FIG. 23F are diagrams illustrating a phase;

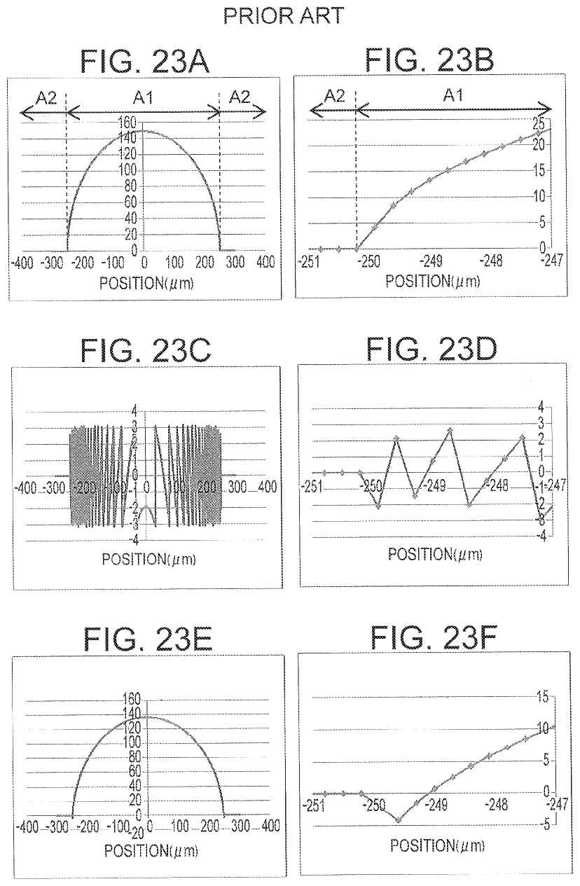

FIG. 24 is a diagram illustrating a sample; and

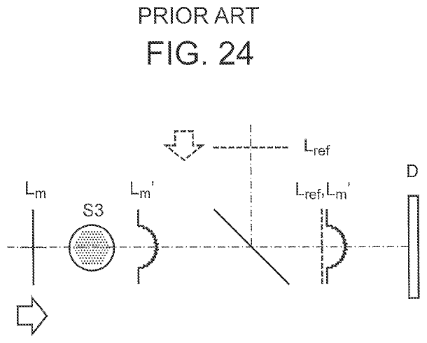

FIG. 25A and FIG. 25B are diagrams illustrating a phase.

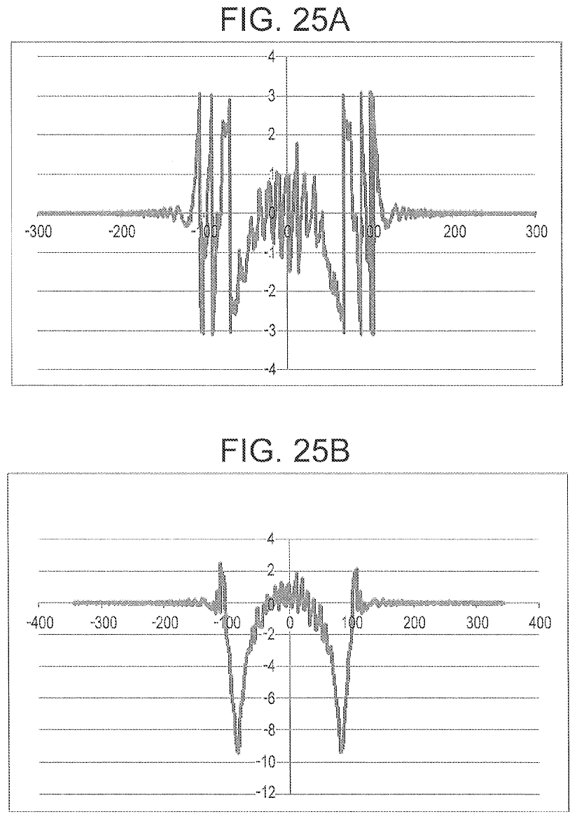

### DETAILED DESCRIPTION

Prior to the explanation of examples, action and effect of embodiments according to certain aspects of the present disclosure will be described below. In the explanation of the action and effect of the embodiments concretely, the explanation will be made by citing concrete examples. However, similar to a case of the examples to be described later, aspects exemplified thereof are only some of the aspects included in the present disclosure, and there exists a large number of variations in these aspects. Consequently, the present disclosure is not restricted to the aspects that will be exemplified.

A sample structure measuring device of the present embodiment includes a light source, an optical path splitting portion configured to split light from the light source into light on a measurement optical path passing through a sample and light on a reference optical path, an optical path merging portion configured to merge light on the measurement optical path and light on the reference optical path, a photodetector having a plurality of pixels and configured to detect incident light from the optical path merging portion and output phase data of the incident light, and a processor. A first region is a region where the sample is present and a second region is a region where the sample is not present. The processor divides the phase data into phase data of the first region and phase data of the second region, sets an initial structure of an estimation sample structure based on the phase data of the first region, and optimizes the estimation sample structure using simulated light transmitted through the estimation sample structure and measurement light transmitted through the sample.

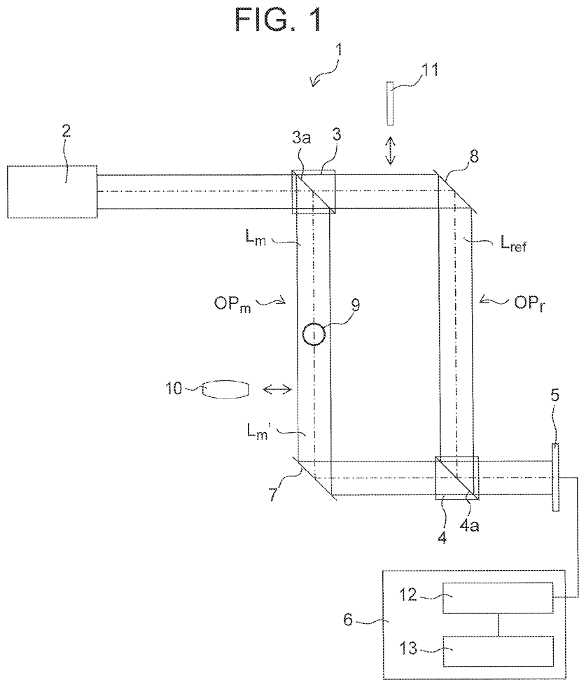

FIG. 1 is a diagram illustrating a sample structure measuring device of the present embodiment. A sample structure measuring device 1 includes a laser 2, a beam splitter 3, a beam splitter 4, a CCD 5, and a processor 6.

In the sample structure measuring device 1, a mirror 7 and a mirror 8 are used. Furthermore, it is possible to use a lens 10 and a light-shielding plate 11, if necessary.

The laser 2 is the light source. The beam splitter 3 is the optical path splitting portion. The beam splitter 4 is the optical path merging portion. The CCD 5 is the photodetector. A CMOS may be used as the photodetector.

The beam splitter 3 includes an optical surface 3a on which an optical film is formed. The beam splitter 4 includes an optical surface 4a on which an optical film is formed. Light traveling to a transmission side and light traveling to a reflection side are generated from incident light by the optical film.

A measurement optical path OPₘ and a reference optical path OPᵣ are formed between the laser 2 and the CCD 5. The measurement optical path OPₘ and the reference optical path OPᵣ are formed by the beam splitter 3.

The measurement optical path OPₘ is positioned on the reflection side of the beam splitter 3. The mirror 7 is disposed on the measurement optical path OPₘ. The measurement optical path OPₘ is bent by the mirror 7. The CCD 5 is disposed on the measurement optical path OPₘ after bending.

The reference optical path OPᵣ is positioned on the transmission side of the beam splitter 3. The mirror 8 is disposed on the reference optical path OPᵣ. The reference optical path OPᵣ is bent by the mirror 8. The reference optical path OPᵣ after bending intersects the measurement optical path OPₘ.

The beam splitter 4 is disposed at a position where the measurement optical path OPₘ and the reference optical path OPᵣ intersect with each other. The measurement optical path OPₘ is positioned on a transmission side of the beam splitter 4.

The reference optical path OPᵣ is bent by the beam splitter 4. The reference optical path OPᵣ is positioned on a reflection side of the beam splitter 4. The reference optical path OPᵣ after bending overlaps the measurement optical path OPₘ.

Laser light emitted from the laser 2 is incident on the beam splitter 3. At the optical surface 3a, light traveling through the measurement optical path OPₘ (hereinafter referred to as “measurement light Lₘ”) and light traveling through the reference optical path OPᵣ (hereinafter referred to as “reference light L_{ref}”) are generated from the light incident on the beam splitter 3.

A sample 9 is positioned on the measurement optical path OPₘ. The sample 9 is held by, for example, a stage (not illustrated). A range wider than the sample 9 is irradiated with the measurement light Lₘ. With irradiation of the measurement light Lₘ, measurement light Lₘ′ is emanated from the sample 9. The measurement light Lₘ′ is reflected by the mirror 7 and thereafter transmitted through the beam splitter 4 and incident on the CCD 5.

Nothing is disposed on the reference optical path OPᵣ. The reference light L_{ref} is reflected by the mirror 8 and thereafter reflected by the beam splitter 4 and incident on the CCD 5.

In the CCD 5, an interference pattern is formed by the measurement light Lₘ′ and the reference light L_{ref} on the image pickup surface of the CCD 5. The interference pattern is captured by the CCD 5. As a result, it is possible to acquire an image of the interference pattern.

In the sample structure measuring device 1, the number of measurement optical paths is one. Furthermore, it is not possible to change the irradiation direction of irradiation light. Thus, an image of one interference pattern is acquired. A process using the image of the interference pattern is performed in the processor 6.

It is possible to use a variety of processors such as a central processing unit (CPU), a graphics processing unit (GPU), or a digital signal processor (DSP) as the processor 6. The number of processors is not limited to one. A plurality of processors may be used.

Furthermore, the processor 6 may be used with a memory. The memory may be a semiconductor memory such as a static random-access memory (SRAM) or a dynamic random-access memory (DRAM), may be a register, may be a magnetic storage device such as a hard disk drive (HDD), or may be an optical storage device such as an optical disc device.

For example, the memory stores therein instructions readable by the processor 6. The instructions stored in the memory are executed by the processor 6, so that a process is performed in accordance with a predetermined procedure.

In the processor 6, the phase data is divided into phase data of the first region and phase data of the second region, an initial structure of an estimation sample structure is set based on the phase data of the first region, and the estimation sample structure is optimized using simulated light transmitted through the estimation sample structure and measurement light transmitted through the sample. The detailed process will be described later.

The processor 6 includes, for example, an initial structure calculating unit 12 and an optimization unit 13. It is possible to perform the process in the processor 6 by the initial structure calculating unit 12 and the optimization unit 13. The initial structure calculating unit 12 and the optimization unit 13 will be described later.

In the sample structure measuring device 1, the lens 10 and the light-shielding plate 11 may be used. It is possible to form an optical image of the sample 9 by using the lens 10 and the light-shielding plate 11. In formation of an optical image, the lens 10 is inserted into the measurement optical path OPₘ between the sample 9 and the CCD 5, and the light-shielding plate 11 is inserted into the reference optical path OPᵣ between the beam splitter 3 and the beam splitter 4.

By doing so, only the measurement light Lₘ′ is incident on the CCD 5. By the measurement light Lₘ′, an optical image is formed on the image pickup surface of the CCD 5. The optical image is captured by the CCD 5. As a result, it is possible to acquire an image of the optical image.

The process in the processor 6 will be described. In the sample structure measuring device 1, since an image of an interference pattern is acquired, it is possible to calculate the phase of electric field from the image of the interference pattern.

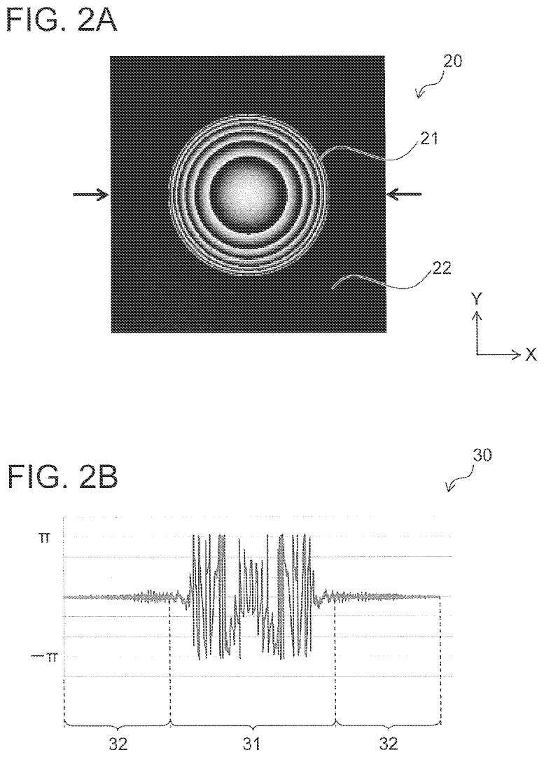

FIG. 2A and FIG. 2B are diagrams illustrating an interference pattern and a wrapped phase. FIG. 2A is a diagram illustrating an interference pattern. FIG. 2B is a diagram illustrating a wrapped phase.

The sample 9 is a sphere. As illustrated in FIG. 2A, an interference pattern 20 is divided into an interference pattern 21 and an interference pattern 22.

The interference pattern 21 is formed based on the measurement light passing through the sample 9. Therefore, the interference pattern 21 is an interference pattern in the first region. The interference pattern 22 is formed based on the measurement light not passing through the sample 9. Therefore, the interference pattern 22 is an interference pattern in the second region.

As described above, a range wider than the sample 9 is irradiated with the measurement light Lₘ. Thus, in the interference pattern 20, the interference pattern 22 is positioned on the outside of the interference pattern 21. That is, in the interference pattern 20, the second region is positioned on the outside of the first region.

The interference pattern 20 is captured by the CCD 5. As a result, two-dimensional discrete data is obtained. The phase of electric field is calculated from the two-dimensional discrete data. Therefore, the phase of electric field is also represented by two-dimensional discrete data.

FIG. 2B illustrates the wrapped phase in the X direction. A wrapped phase 30 (hereinafter referred to as “phase 30”) is the phase at a position indicated by the arrows in FIG. 2A.

As illustrated in FIG. 2B, the phase 30 is divided into a phase 31 and a phase 32.

The phase 31 is a phase of a portion in which the sample 9 is present. Thus, the phase 31 is a phase in the first region. The phase 32 is a phase of a portion in which the sample 9 is not present. Thus, the phase 32 is a phase in the second region.

In the interference pattern 20, the second region is positioned on the outside of the first region. Therefore, the second region is positioned on the outside of the first region also in the phase 30.

A boundary line between the first region and the second region represents a shape of the sample 9. Furthermore, a size of the first region represents a size of the sample 9. Therefore, it is possible to calculate the shape of the sample 9 and the size of the sample 9 from a shape of the first region and the size of the first region.

In the sample structure measuring device 1, only the wrapped phase is used in calculation of the shape of the first region and calculation of the size of the first region. That is, in the sample structure measuring device 1, the unwrapped phase is not used.

In a method using the unwrapped phase, whether the shape of the sample is calculated and the size of the sample is calculated depends on the size of the sample. By comparison, in a method using the wrapped phase, whether the shape of the sample is calculated and the size of the sample is calculated does not depend on the size of the sample. Thus, in the sample structure measuring device 1, it is possible to calculate the shape of the sample and the size of the sample, independently of the size of the sample.

In the sample structure measuring device 1, Inverse Radon transform is not used. Then, in the sample structure measuring device 1, optimization of the refractive index distribution is performed. In optimization of the refractive index distribution, an estimation sample structure is used. By performing optimization of the refractive index distribution, it is possible to calculate the refractive index distribution of the estimation sample structure.

The estimation sample structure includes a structure included in the first region and a structure included in the second region. When the refractive index distribution of the estimation sample structure is calculated, the refractive index distribution of the first region is calculated. The refractive index distribution of the sample 9 is obtained from the calculated refractive index distribution.

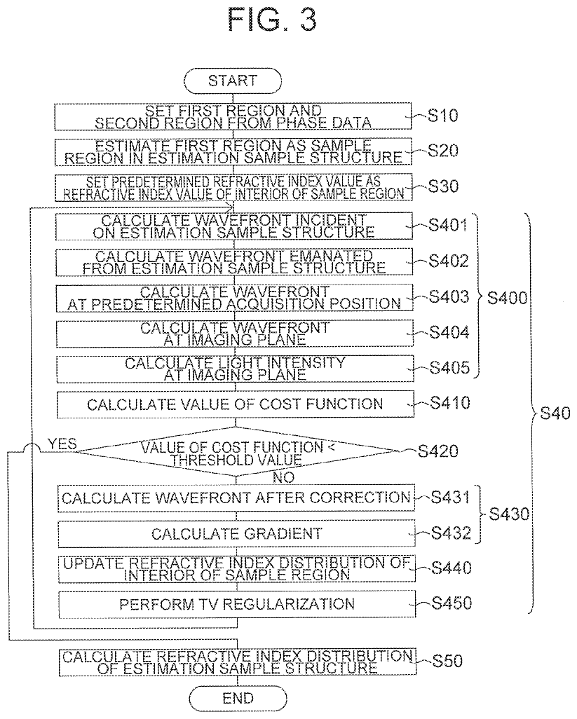

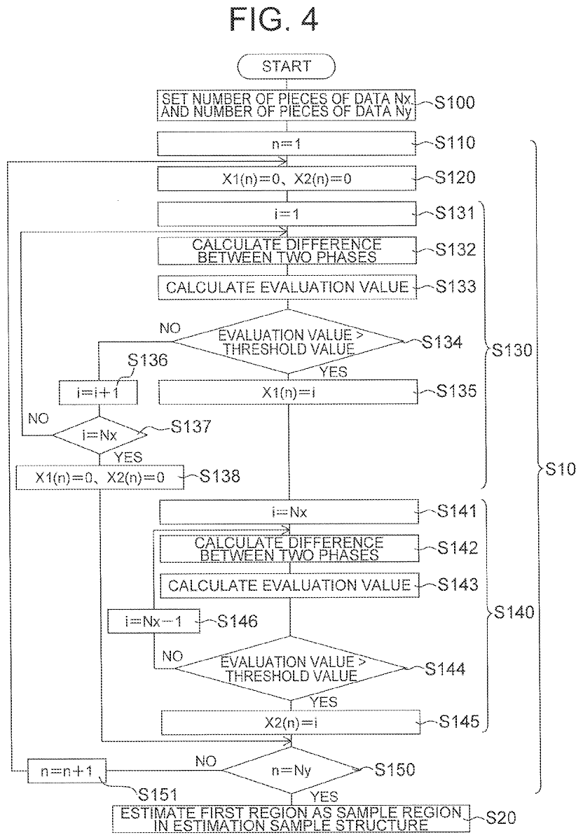

A method of calculating the refractive index distribution will be described. FIG. 3 is a flowchart of a first calculation method. FIG. 4 is a flowchart at step S10.

In the first calculation method, an image of one interference pattern is used. As described above, in the sample structure measuring device 1, an image of one interference pattern is acquired. Therefore, it is possible to use the first calculation method in the sample structure measuring device 1.

The first calculation method includes step S10, step S20, step S30, step S40, and step S50.

At step S10, the first region and the second region are set from the phase data.

As illustrated in FIG. 4, step S10 includes step S100, step S110, step S120, step S130, step S140, and step S150.

The phase data is data of the wrapped phase. Step S10 is performed whereby the phase data is divided into phase data of the first region and phase data of the second region.

The phase data is calculated, for example, from the interference pattern 20 illustrated in FIG. 2A. In this case, the phase data is represented by two-dimensional discrete data. The number of data in the X direction is expressed as Nx, and the number of data in the Y direction is expressed as Ny. The X direction and the Y direction are the same as the X direction and the Y direction illustrated in FIG. 2A.

It is possible to consider Nx as the number of data in one row. In this case, Ny represents the number of rows in the Y direction. At step S10, the first region and the second region are set for each row. Hereinafter, the phase data in one row is referred to as “phase data L”.

The setting of the first region and the second region in the phase data L includes a case where it is possible to set the first region and a case where it is not possible to set the first region. In the case where it is possible to set the first region, it is possible to divide the phase data L into phase data of the first region and phase data of the second region. In the case where it is not possible to set the first region, the phase data L is only the phase data of the second region.

At step S100, the number of data Nx and the number of data Ny are set.

At step S110, 1 is set as the value of a variable n.

The variable n represents the ordinal number of the phase data L in the Y direction. When n=1, the first phase data L is used at step S130 and step S140.

At step S120, the value of X1(n) and the value of X2(n) are initialized. In the initialization, zero is set as the value of X1(n) and the value of X2(n).

When the second region is positioned on the outside of the first region, the number of boundaries between the first region and the second region is at most two. One of the two boundaries is expressed as first boundary, and the other is expressed as second boundary. In X1(n), information about the first boundary is stored. In X2(n), information about the second boundary is stored.

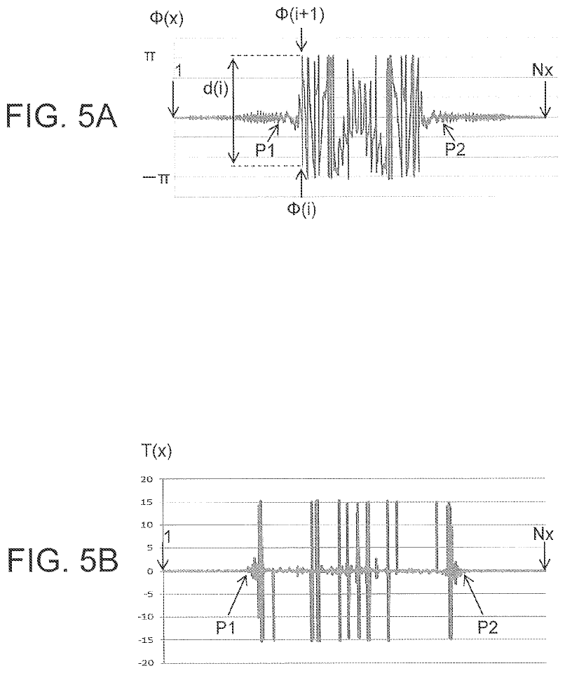

FIG. 5A and FIG. 5B are diagrams illustrating one-dimensional phase data and an evaluation value. FIG. 5A is a diagram illustrating a wrapped one-dimensional phase data. FIG. 5B is a diagram illustrating an evaluation value.

As described above, step S10 is performed whereby the phase data is divided into the phase data of the first region and the phase data of the second region. In order to divide the phase data, it is necessary to calculate a position of the first boundary P1 and a position of the second boundary P2 for each piece of the phase data L.

Calculation of the position of the first boundary P1 is performed at step S130. Calculation of the position of the second boundary P2 is performed at step S140.

At step S130, the position of the first boundary is calculated.

Step S130 includes step S131, step S132, step S133, step S134, step S135, step S136, step S137, and step S138.

At step S131, 1 is set as the value of a variable i.

As illustrated in FIG. 5A, the position of the first boundary P1 is closer to the position of the first data than the position of the Nx-th data. It is preferable that the calculation of the position of the first boundary P1 start from the first data.

In the sample structure measuring device of the present embodiment, it is preferable that the phase data be divided by comparing an evaluation value with a threshold value, phase data in one row be used in calculation of the evaluation value, and the evaluation value be calculated based on a difference between adjacent two phases.

At step S132, the difference between two phases is calculated.

In calculation of the position of the first boundary P1 and the position of the second boundary P2, an evaluation value is compared with a threshold value. In calculation of the evaluation value, phase data in one row is used. The phase data in one row is the phase data L. The evaluation value is calculated based on the difference between two phases.

In calculation of the difference between two phases, as illustrated in FIG. 5A, it is possible to use adjacent two phases.

In this case, the difference d(i) is represented by the following Expression (1):

$$d ( i ) = φ ( i + 1 ) - φ ( i ) \qquad ( 1 )$$

where

φ(i) is the i-th phase, and

φ(i+1) is the (i+1)-th phase.

At step S133, the evaluation value is calculated.

The evaluation value T(i) is represented by the following Expression (2):

$$T ( i ) = d ( i ) \times λ \text{/} p \qquad ( 2 )$$

where

λ is a wavelength, and

p is a size of a pixel on a sample surface.

The size of a pixel on a sample surface is a size obtained when a pixel of the photodetector is converted into a pixel on the sample surface.

At step S134, comparison between the evaluation value and the threshold value is performed.

As illustrated in FIG. 5B, the evaluation value T(i) has a positive value and a negative value. Therefore, comparison with the threshold value is performed using the absolute value of the evaluation value T(i).

For example, it is possible to set 5π as the threshold value. It is possible to set a lower limit value and an upper limit value for the threshold value. A preferable lower limit value is 0 or 0.2π. A preferable upper limit value is 5π or π.

If the determination result is YES, step S135 is performed. If the determination result is NO, step S136 is performed.

The method of calculating the evaluation value T(i) is not limited to the difference. For example, the evaluation value T(i) may be calculated by differentiating the phase φ(i). When a differential value of the phase φ(i) is used as the evaluation value T(i), a threshold value different from the threshold value used in comparison of the difference d(i) is used in comparison between the evaluation value T(i) and the threshold value.

### (If the Determination Result is YES: The Evaluation Value>the Threshold Value)

At step S135, the value of i is set as the value of X1(n).

The sample is not present in the second region. In the second region, the difference between adjacent two phases is extremely small. On the other hand, the sample is present in the first region. Thus, the difference between adjacent two phases becomes large first at the boundary between the first region and the second region.

The evaluation value T(i) includes information on the difference between adjacent two phases. Therefore, by comparing the evaluation value with the threshold value, it is possible to calculate the boundary between the first region and the second region.

As described above, the position of the first boundary P1 is closer to the position of the first data than the position of the Nx-th data. The calculation of the evaluation value starts from the first data. Therefore, as illustrated in FIG. 5B, the value stored in X1(n) represents the position of the first boundary P1.

### (If the Determination Result is NO: The Evaluation Value≤the Threshold Value)

At step S136, 1 is added to the value of the variable i.

At step S137, it is determined whether the value of the variable i matches the number of data Nx.

If the determination result is YES, step S138 is performed. If the determination result is NO, the process returns to step S132.

(If the Determination Result is YES: i=Nx)

At step S138, zero is set as the value of X1(n) and the value of X2(n).

The comparison between the evaluation value and the threshold value is performed until the position of the first boundary is calculated or the phases of all of the phase data L are used.

When the position of the first boundary is calculated, the value of the variable i is smaller than the number of data Nx. Therefore, the match of the value of the variable i with the number of data Nx means that the position of the first boundary has failed to be calculated although the phases of all of the phase data L have been used.

When the position of the first boundary fails to be calculated even using the phases of all of the phase data L, it is not possible to calculate the position of the second boundary, either. Therefore, zero is set as the value of X1(n) and the value of X2(n). This means that it is not possible to set the first region in the phase data L. In this case, the phase data L is only the phase data of the second region.

When step S138 is finished, the process proceeds to step S150.

(If the Determination Result is NO: i≠Nx)

The process returns to step S132.

The mismatch of the value of the variable i with the number of data Nx means that comparison between the evaluation value and the threshold value is not performed using the phases of all of the phase data L.

At step S136, the value of the variable i is increased by one. Thus, step S132, step S133, and step S134 are performed using other adjacent two phases.

When step S130 is finished, step 140 is performed.

At step S140, the position of the second boundary is calculated.

Step S140 includes step S141, step S142, step S143, step S144, step S145, and step S146.

At step S141, the number of data Nx is set as the value of the variable i.

As illustrated in FIG. 5A, the position of the second boundary P2 is closer to the position of the Nx-th data than the position of the first data. It is preferable that the calculation of the position of the second boundary P2 start from the Nx-th data.

At step S142, the difference between two phases is calculated.

The difference d(i) is represented by the following

Expression (3):

$$d ( i ) = φ ( i ) - φ ( i - 1 ) \qquad ( 3 )$$

where

φ(i) is the i-th phase, and

φ(i−1) is the (i−1)-th phase.

At step S143, the evaluation value is calculated.

The evaluation value T(i) is represented by Expression (2) above.

At step S144, comparison between the evaluation value and the threshold value is performed.

As described above, the evaluation value T(i) has a positive value and a negative value. Therefore, comparison with the threshold value is performed using the absolute value of the evaluation value T(i).

For example, it is possible to set 5π as the threshold value. It is possible to set a lower limit value and an upper limit value for the threshold value. A preferable lower limit value is 0 or 0.2π. A preferable upper limit value is 5π or π.

If the determination result is YES, step S145 is performed. If the determination result is NO, step S146 is performed.

### (If the Determination Result is YES: The Evaluation Value>the Threshold Value)

At step S145, the value of i is set as the value of X2(n).

As described above, the position of the second boundary P2 is closer to the position of the Nx-th data than the position of the first data. The calculation of the evaluation value starts from the Nx-th data. Therefore, as illustrated in FIG. 5B, the value stored in X2(n) represents the position of the second boundary P2.

### (If the Determination Result is NO: The Evaluation Value the Threshold Value)

At step S146, 1 is subtracted from the value of the variable i.

When step S146 is finished, the process returns to step S142. At step S146, the value of the variable n is decreased by one. Thus, step S142, step S143, and step S144 are performed for other adjacent two pixels.

When step S145 is finished, the positions of two boundaries are calculated in the phase data L. As a result, the first region and the second region are set in the phase data L.

As described above, when it is not possible to calculate the position of the first boundary, step S140 is not performed. Therefore, at step S140, the position of the second boundary is always calculated.

The setting of the first region and the setting of the second region have to be performed in all of the phase data L.

At step S150, it is determined whether the value of the variable n matches the number of data Ny.

If the determination result is NO, step S151 is performed. If the determination result is YES, step S20 is performed.

(If the Determination Result is YES: n=Ny)

Step S20 is performed.

(If the Determination Result is NO: n≠Ny)

At step S151, 1 is added to the value of the variable n.

When step S151 is finished, the process returns to step S120. At step S151, the value of the variable n is increased by one. Thus, for another phase data L, step S130 and step S140 are performed.

Step S130 and step S140 are repeatedly performed until the position of the first boundary and the position of the second boundary are calculated for all of the phase data L.

The shape of the first region and the size of the first region represent the shape of the region where the sample is present and the size of the region where the sample is present. Therefore, by dividing the phase data into the phase data of the first region and the phase data of the second region, it is possible to calculate the shape of the region where the sample is present and the size of the region where the sample is present.

As described above, in the processor 6, an initial structure of an estimation sample structure is set based on the phase data of the first region. The initial structure can include the shape of the first region, the size of the first region, the shape of the second region, the size of the second region, the refractive index distribution of the first region, and the refractive index distribution of the second region.

In this case, in the setting of the initial structure based on the phase data of the first region, setting of the shape of the first region, setting of the size of the first region, setting of the shape of the second region, and setting of the size of the second region are performed. The setting of the refractive index distribution of the first region and the setting of the refractive index distribution of the second region are performed separately.

At step S20, the first region is estimated as a sample region in the estimation sample structure.

In optimization of the refractive index distribution, estimation of the refractive index distribution is performed. The estimation of the refractive index distribution is performed by simulation. Since the simulation is performed using the estimation sample structure, the shape of the estimation sample structure and the size of the estimation sample structure are necessary.

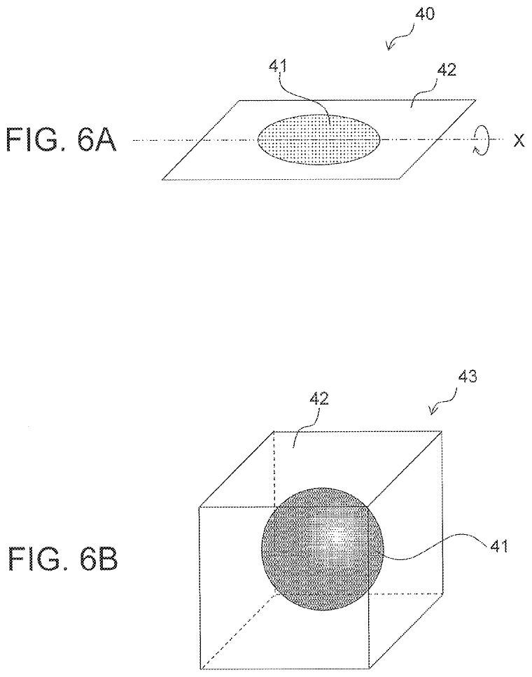

FIG. 6A and FIG. 6B are diagrams illustrating the first region and the second region. FIG. 6A is a diagram depicting two regions in two dimensions. FIG. 6B is a diagram depicting two regions in three dimensions.

Step S10 is performed whereby the position of the first boundary and the position of the second boundary are calculated in each piece of the phase data L. It is possible to obtain a two-dimensional structure from the calculated positions. As illustrated in FIG. 6A, a two-dimensional structure 40 includes a first region 41 and a second region 42.

Since the sample 9 is a sphere, the estimation sample structure is represented by a three-dimensional structure. In order to represent the estimation sample structure in a three-dimensional structure, a three-dimensional structure of the first region 41 and a three-dimensional structure of the second region 42 are necessary.

The two-dimensional structure 40 includes the first region 41 and the second region 42. Therefore, a three-dimensional structure of the first region 41 and a three-dimensional structure of the second region 42 are obtained by rotating the two-dimensional structure 40 around the X axis.

A three-dimensional structure of the estimation sample structure is determined from the three-dimensional structure of the first region 41 and the three-dimensional structure of the second region 42. As illustrated in FIG. 6B, an estimation sample structure 43 includes the first region 41 and the second region 42.

The shape of the first region 41 and the size of the first region 41 represent the shape of the sample and the size of the sample. Therefore, the first region 41 only needs to be estimated as a sample region in the estimation sample structure.

At step S30, a predetermined refractive index value is set as the refractive index value of the interior of the sample region.

In order to perform estimation of the refractive index distribution, the refractive index distribution of the sample region is necessary. It is possible to consider the sample region as the first region. At step S10, it is possible to calculate the shape of the first region and the size of the first region, but it is not possible to calculate the refractive index distribution of the first region. Thus, it is necessary to set the refractive index distribution of the sample region by a different method.

In the first calculation method, a predetermined refractive index value is set as the refractive index value of the interior of the sample region. For example, it is possible to set 1 as the predetermined refractive index value. With this setting, the initial structure of the estimation sample structure is set.

The outside of the sample region corresponds to the second region. The sample 9 is not present in the second region. Therefore, for example, zero only needs to be set as the refractive index value of the outside of the sample region.

At step S40, optimization of the refractive index distribution is performed.

Step S40 includes step S400, step S410, step S420, step S430, step S440, and step S450.

In the optimization, for example, a cost function is used. The cost function is represented by the difference between a measured value of the measurement light and an estimation value by simulation or the ratio between a measured value of the measurement light and an estimation value by simulation. The estimation value is calculated using light transmitted through the estimation sample structure. The light transmitted through the estimation sample structure is light by simulation.

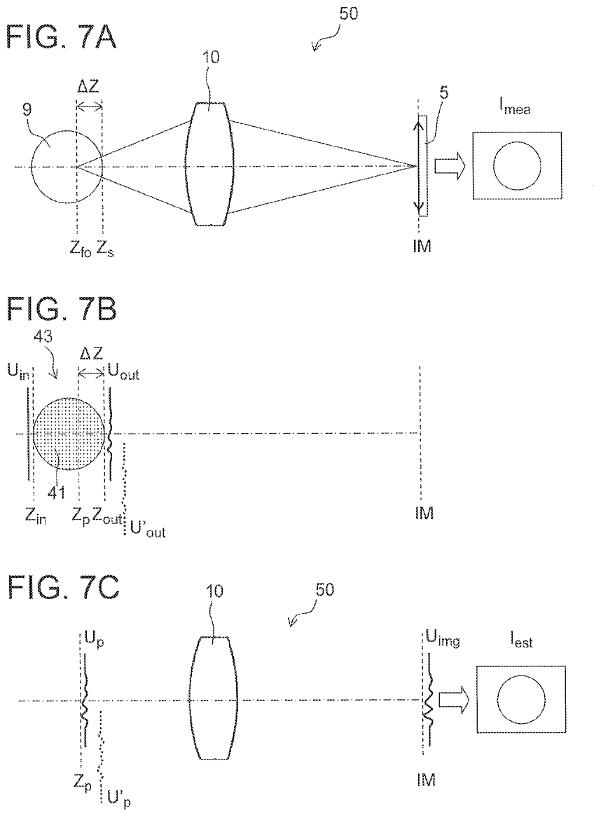

FIG. 7A, FIG. 7B, and FIG. 7C are diagrams illustrating a measurement image and an estimation image. FIG. 7A is a diagram illustrating appearance of acquiring a measurement image. FIG. 7B and FIG. 7C are diagrams illustrating appearance of acquiring an estimation image.

The measured value of the measurement light (hereinafter referred to as “measured value”) is calculated from the measurement image. As illustrated in FIG. 7A, in acquisition of the measurement image, the sample 9 and a measurement optical system 50 are used. It is possible to form the measurement optical system 50 by positioning the lens 10 on the measurement optical path OPₘ in the sample structure measuring device 1 illustrated in FIG. 1.

In FIG. 7A, a position Z_{fo} indicates the position of the focal point of the measurement optical system 50. A position Zₛ indicates a position of the image-side surface of the sample 9.

In the measurement optical system 50, an optical image of the sample 9 at the position Z_{fo} is formed on an imaging plane IM. In FIG. 7A, the interior of the sample 9 which is away from the position Zₛ by ΔZ matches the position Z_{fo}.

The CCD 5 is disposed on the imaging plane IM. An optical image of the sample 9 is captured by the CCD 5. As a result, it is possible to acquire an image of the optical image of the sample 9 (hereinafter referred to as “measurement image Iₘₑₐ”). The measured value is calculated from the measurement image Iₘₑₐ.

The estimation value by simulation (hereinafter referred to as “estimation value”) is calculated from an image of an optical image of the estimation sample structure 43 (hereinafter referred to as “estimation image Iₑₛₜ”). In the estimation sample structure 43 illustrated in FIG. 7B, only the sample region is depicted.

FIG. 7C depicts the measurement optical system 50. Since calculation of the estimation image Iₑₛₜ is performed by simulation, the measurement optical system 50 does not exist physically. Thus, in calculation of the estimation image Iₑₛₜ, a pupil function of the measurement optical system 50 is used.

The estimation image Iₑₛₜ is represented by the light intensity of the estimation sample structure 43 at the imaging plane IM. Therefore, it is necessary to calculate the light intensity of the estimation sample structure 43 at the imaging plane IM.

At step S400, the light intensity at the imaging plane is calculated.

Step S400 includes step S401, step S402, step S403, step S404, and step S405.

The calculation of the light intensity at the imaging plane is performed based on forward propagation of wavefronts. In the forward propagation, as illustrated in FIG. 7B and FIG. 7C, wavefronts propagate from the estimation sample structure 43 toward the imaging plane IM.

At step S401, a wavefront incident on the estimation sample structure is calculated.

A position Zᵢₙ is a position of the object-side surface of the sample region 41. Therefore, a wavefront Uᵢₙ at the position Zᵢₙ is calculated. For the wavefront Uᵢₙ, it is possible to use the same wavefront as a wavefront of the measurement light Lₘ irradiating the sample 9.

At step S402, a wavefront emanated from the estimation sample structure is calculated.

A position Zₒᵤₜ is the position of the image-side surface of the sample region 41. Therefore, a wavefront Uₒᵤₜ at the position Zₒᵤₜ is calculated. It is possible to calculate the wavefront Uₒᵤₜ from the wavefront Um, for example, using a beam propagation method.

At step S403, a wavefront at a predetermined acquisition position is calculated.

The predetermined acquisition position is a position on the sample side when the measurement image is acquired.

The estimation image Iₑₛₜ is calculated under the same condition as that for the measurement image Iₘₑₐ. The measurement image Iₘₑₐ is acquired from the optical image of the interior of the sample 9 which is away from the position Zₛ by ΔZ. Therefore, in calculation of the estimation image Iₑₛₜ, the wavefront at the position which is away from the position Zₛ by ΔZ is necessary.

In FIG. 7B, the position Zₒᵤₜ corresponds to the position Zₛ. The position which is away from the position Zₒᵤₜ by ΔZ is a position Zₚ. Therefore, a wavefront Uₚ at the position Zₚ only needs to be calculated.

The position Zₚ is away from the position Zₒᵤₜ by ΔZ. Therefore, it is not possible to use the wavefront Uₒᵤₜ as the wavefront Uₚ. It is possible to calculate the wavefront Uₚ from the wavefront Uₒᵤₜ, for example, using a beam propagation method.

At step S404, a wavefront at the imaging plane is calculated.

The wavefront Uₚ passes through the measurement optical system 50 and reaches the imaging plane IM. It is possible to calculate a wavefront U_{img} at the imaging plane IM using the wavefront Uₚ and the pupil function of the measurement optical system 50.

At step S405, light intensity at the imaging plane is calculated.

The wavefront U_{img} represents the amplitude of light. The light intensity is represented by the square of the amplitude. Therefore, by raising the wavefront U_{img} to the power of 2, it is possible to calculate the light intensity of the sample region 41. As a result, it is possible to acquire the estimation image Iₑₛₜ. The estimation value is calculated from the estimation image Iₑₛₜ.

The amplitude and the phase may be used instead of the light intensity. The amplitude and the phase are represented by an electric field. Therefore, when the amplitude and the phase are used, a value calculated from an electric field is used for the measured value and the estimation value. An electric field Emes based on measurement and an electric field Eest based on estimation are represented by the following expressions.

$$Emes = Ames \times exp ( i \times Pmes )$$

$$Eest = Aest \times exp ( i \times Pest )$$

where

Pmes is a phase based on measurement,

Ames is an amplitude based on measurement,

Pest is a phase based on estimation, and

Aest is an amplitude based on estimation.

In acquisition of the electric field Emes based on measurement, for example, in the sample structure measuring device illustrated in FIG. 1, the mirror 7 only needs to be slightly tilted or the mirror 8 only needs to be slightly tilted. By doing so, the measurement light Lₘ′ and the reference light L_{ref} are incident in a non-parallel state on the CCD 5.

In the CCD 5, an interference pattern is formed by the measurement light Lₘ′ and the reference light L_{ref} on the image pickup surface of the CCD 5. The interference pattern is captured by the CCD 5. As a result, it is possible to acquire an image of the interference pattern.

The interference pattern is acquired in a state in which the measurement light Lₘ′ and the reference light L_{ref} are in a non-parallel state. Therefore, by analyzing this interference pattern, it is possible to obtain the phase based on measurement and the amplitude based on measurement. As a result, the electric field Emes based on measurement is obtained. It is possible to obtain the electric field Eest based on estimation by simulation.

At step S410, a value of the cost function is calculated.

The measured value is calculated from the measurement image Iₘₑₐ. The estimation value is calculated from the estimation image Iₑₛₜ. It is possible to represent the cost function by the difference between the measured value and the estimation value or the ratio between the measured value and the estimation value.

At step S420, comparison between the value of the cost function and the threshold value is performed.

When the cost function is represented by the difference between the measured value and the estimation value, the difference between the measured value and the estimation value is calculated as the value of the cost function. The value of the cost function is compared with the threshold value. If the determination result is NO, step S430 is performed. If the determination result is YES, step S50 is performed.

### (If the Determination Result is NO: The Value of the Cost Function≥the Threshold Value)

At step S430, a gradient is calculated.

Step S430 includes step S431 and step S432.

Calculation of the gradient is based on reverse propagation of wavefronts. In the reverse propagation, wavefronts propagate from the position Zₒᵤₜ toward the position Zᵢₙ.

At step S431, a wavefront after correction is calculated.

In calculation of a wavefront U′ₚ after correction, the measurement image Iₘₑₐ and the estimation image Iₑₛₜ are used. The wavefront U′ₚ is the wavefront at the position Zₚ.

As illustrated in FIG. 7C, the estimation image Iₑₛₜ is calculated based on the wavefront U_{img}. Furthermore, the wavefront U_{img} is calculated based on the wavefront Uₚ.

In calculation of the wavefront Uₚ, the predetermined refractive index value set at step S30 is used. The predetermined refractive index value is the estimated refractive index value. When step S430 is performed for the first time, the predetermined refractive index value is different from the refractive index value of the sample 9.

As the difference between the predetermined refractive index value and the refractive index value of the sample 9 increases, the difference between the estimation image Iₑₛₜ and the measurement Iₘₑₐ also increases. Therefore, it is possible to assume that the difference between the estimation image Iₑₛₜ and the measurement image Iₘₑₐ reflects the difference between the predetermined refractive index value and the refractive index value of the sample 9.

Then, the wavefront Uₚ is corrected using the estimation image Iₑₛₜ(r) and the measurement image Iₘₑₐ(r). As a result, the wavefront after correction, that is, the wavefront U′ₚ is obtained.

The wavefront U′ₚ is represented by, for example, the following Expression (4):

$${{U}^{′}}_{p} = {U}_{p} \times ( {I}_{mea} / {I}_{est} ) . \qquad ( 4 )$$

At step S432, a gradient is calculated.

It is possible to perform calculation of the gradient based on the reverse propagation of the wavefront.

In the reverse propagation of the wavefront, the wavefront from the position Zₒᵤₜ toward the position Zᵢₙ is calculated. Therefore, in order to calculate the gradient, the wavefront after correction at the position Zₒᵤₜ (hereinafter referred to as “wavefront U′ₒᵤₜ”) is necessary.

Since the wavefront U′ₚ is the wavefront obtained by correcting the Uₚ, the wavefront U′ₚ is the wavefront at the position Zₚ. In FIG. 7C, the wavefront U′ₚ is depicted at a position shifted from the position Zₚ, for the sake of visibility. Furthermore, in FIG. 7B, the wavefront U′ₒᵤₜ is depicted at a position shifted from the position Zₒᵤₜ.

As illustrated in FIG. 7B and FIG. 7C, the position Zₒᵤₜ is away from the position Zₚ by ΔZ. Therefore, it is not possible to use the wavefront U′ₚ as the wavefront U′ₒᵤₜ. It is possible to calculate the wavefront U′ₒᵤₜ from the wavefront U′ₚ, for example, using a beam propagation method.

When the wavefront U′ₒᵤₜ is calculated, calculation of the wavefront is performed based on the reverse propagation of the wavefront. In the reverse propagation of the wavefront, the wavefront propagating through the interior of the estimation sample structure 42 is calculated. In calculation of the wavefront, the wavefronts Uₒᵤₜ and U′ₒᵤₜ are used.

The wavefront U′ₚ is different from the wavefront Uₚ. Therefore, the wavefront U′ₒᵤₜ is also different from the wavefront Uₒᵤₜ. It is possible to calculate the gradient by using the wavefront U′ₒᵤₜ and the wavefront Uₒᵤₜ. The gradient includes information about a new refractive index value.

At step S440, the refractive index distribution of the interior of the sample region is updated.

When step S430 is performed for the first time, the gradient includes information about the difference between a predetermined refractive index distribution and the refractive index distribution of the sample 9. Therefore, the updated refractive index distribution is obtained by adding the gradient to the predetermined refractive index distribution.

The updated refractive index distribution is closer to the refractive index distribution of the sample 9 than the predetermined refractive index distribution is. Therefore, it is possible to update the refractive index distribution of the interior of the sample region 41 using the updated refractive index distribution.

At step S450, TV regularization is performed.

By performing TV regularization, it is possible to perform noise removal and correction of a blurred image.

When step S450 is finished, the process returns to step S40. The updated refractive index distribution is set in the refractive index distribution of the interior of the sample region 41. Step S40 is performed using the updated refractive index distribution.

Step S40 is repeatedly performed whereby the updated refractive index distribution gradually approaches the refractive index distribution of the sample 9. That is, the value of the cost function becomes smaller.

Eventually, the value of the cost function becomes smaller than the threshold value.

### (If the Determination Result is YES: The Value of the Cost Function<the Threshold Value)

At step S50, the refractive index distribution of the estimation sample structure 43 is calculated.

The obtained refractive index distribution is identical or substantially identical with the refractive index distribution of the sample 9. It is possible to obtain a reconstructed estimation sample by using the refractive index distribution obtained at step S50.

It is possible to output the reconstructed estimation sample structure to, for example, a display device.

As described above, the refractive index distribution obtained at step S50 is identical or substantially identical with the refractive index distribution of the sample 9. Therefore, it is possible to assume that the reconstructed estimation sample structure is identical or substantially identical with the structure of the sample 9.

In the first calculation method, the shape of the first region and the size of the first region are calculated using phase data. This phase data is data of the wrapped phase. Therefore, it is possible to accurately measure the refractive index distribution of the sample, regardless of the size of the sample.

In the sample structure measuring device 1, the number of measurement optical paths is one. Furthermore, it is not possible to change the irradiation direction of irradiation light. In this case, an image of an interference pattern viewed from one direction is acquired. Thus, the shape of the first region and the size of the first region are calculated based on information obtained when the sample 9 is viewed from one direction.

Therefore, for example, when it is known that the shape of the sample is a close-to-sphere shape or a close-to-cube shape, it is possible to calculate the shape of the first region and the size of the first region more accurately. Furthermore, it is possible to accurately measure the refractive index distribution of the sample, regardless of the size of the sample.

In the sample structure measuring device of the present embodiment, it is preferable that the phase data be divided by comparing an evaluation value with a threshold value, phase data in one row be used in calculation of the evaluation value, and the evaluation value be calculated based on a difference between an initial phase and another phase or a difference between the last phase and another phase.

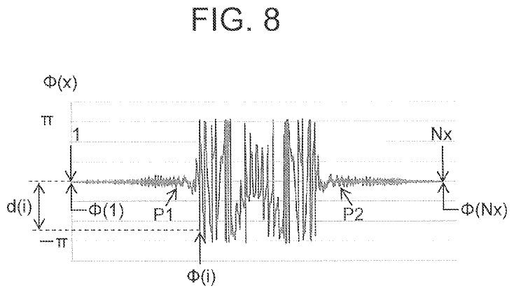

FIG. 8 is a diagram illustrating a wrapped one-dimensional phase data.

In calculation of the difference between two phases, as illustrated in FIG. 8, it is possible to use the initial phase and another phase, or the last phase and another phase.

In this case, for the difference d(i), the following Expression (1′) is used instead of Expression (1), and the following Expression (3′) is used instead of Expression (3):

$$d ( i ) = φ ( i ) - φ ( 1 ) \qquad ( {1}^{′} )$$

where

φ(1) is the first phase, and

φ(i) is the i-th phase.

$$d ( i ) = φ ( i ) - φ ( Nx ) \qquad ( {3}^{′} )$$

where

φ(i) is the i-th phase, and

φ(Nx) is the Nx-th phase.

When Expression (1′) and Expression (3′) are used, it is possible to set, for example, 0.8π as a threshold value. It is possible to set a lower limit value and an upper limit value for the threshold value. A preferable lower limit value is 0 or 0.1π. A preferable upper limit value is 0.8π or 0.5π.

The number of data in one row is Nx. Therefore, the initial phase is the phase positioned in the first place in the phase data L. Furthermore, the last phase is the phase positioned in the Nx-th place in the phase data L.

The sample structure measuring device of the present embodiment may include a plurality of measurement optical paths.

The number of measurement optical paths in the sample structure measuring device is not limited to one. The number of measurement optical paths in the sample structure measuring device may be, for example, two.

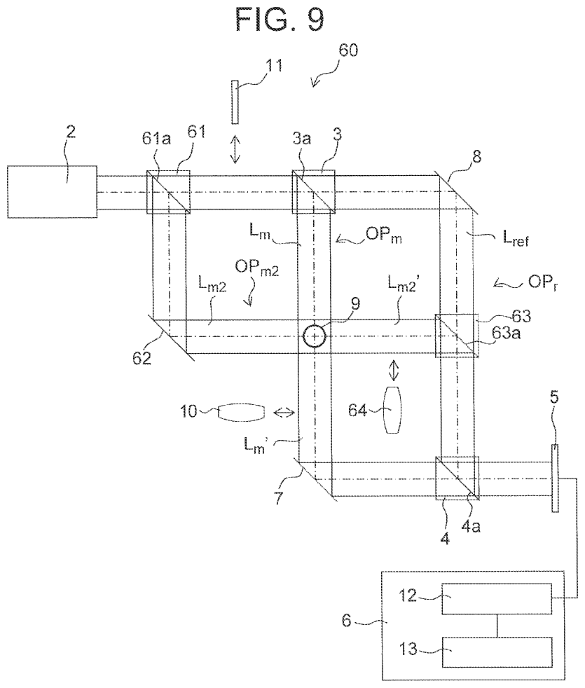

FIG. 9 is a diagram illustrating a sample structure measuring device of the present embodiment. The same configuration as that in FIG. 1 is denoted by the same numeral and a description thereof is omitted.

A sample structure measuring device 60 includes a beam splitter 61, a mirror 62, a beam splitter 63, and a lens 64.

The beam splitter 61 is disposed between the laser 2 and the beam splitter 3. The beam splitter 63 is disposed between the mirror 8 and the beam splitter 4.

The beam splitter 61 includes an optical surface 61a on which an optical film is formed. The beam splitter 63 includes an optical surface 63a on which an optical film is formed. Light traveling to the transmission side and light traveling to the reflection side are generated from incident light by the optical film.

A measurement optical path OPₘ₂ is formed between the laser 2 and the CCD 5. The measurement optical path OPₘ₂ is formed by the beam splitter 61.

The measurement optical path OPₘ₂ is positioned on the reflection side of the beam splitter 61. The mirror 62 is disposed on the measurement optical path OPₘ₂.

The measurement optical path OPₘ₂ is bent by the mirror 62. The measurement optical path OPₘ₂ after bending intersects the measurement optical path OPₘ and the reference optical path OPᵣ.

The beam splitter 63 is disposed at the position where the measurement optical path OPₘ₂ and the reference optical path OPᵣ intersect with each other. The reference optical path OPᵣ is positioned on the transmission side of the beam splitter 63.

The measurement optical path OPₘ₂ is bent by the beam splitter 63. The measurement optical path OPₘ₂ is positioned on the reflection side of the beam splitter 63. The measurement optical path OPₘ₂ after bending overlaps the reference optical path OPᵣ.

The measurement optical path OPₘ₂ and the reference optical path OPᵣ are bent by the beam splitter 4. The measurement optical path OPₘ, the measurement optical path OPₘ₂, and the reference optical path OPᵣ are positioned on the reflection side of the beam splitter 4.

Laser light emitted from the laser 2 is incident on the beam splitter 61. At the optical surface 61a, the light incident on the beam splitter 61 is split into light traveling through the measurement optical path OPₘ₂ (hereinafter referred to as “measurement light Lₘ₂”), and measurement light Lₘ and reference light L_{ref}.

The sample 9 is positioned on the measurement optical path OPₘ₂. A range wider than the sample 9 is irradiated with the measurement light Lₘ₂. With irradiation of the measurement light Lₘ₂, measurement light Lₘ₂′ is emanated from the sample 9. The measurement light Lₘ₂′ is reflected by the beam splitter 63 and thereafter reflected by the beam splitter 4 and incident on the CCD 5.

When the measurement light Lₘ₂′ is blocked, an interference pattern (hereinafter referred to as “first interference pattern”) is formed by the measurement light Lₘ′ and the reference light L_{ref} on the image pickup surface in the CCD 5. Furthermore, when the measurement light Lₘ′ is blocked, an interference pattern (hereinafter referred to as “second interference pattern”) is formed by the measurement light Lₘ₂′ and the reference light L_{ref} on the image pickup surface in the CCD 5. The interference pattern is captured by the CCD 5. As a result, it is possible to acquire an image of the interference pattern.

In the sample structure measuring device 60, the lens 64 may be used. In this case, an optical image of the sample 9 is formed in the sample structure measuring device 60. In formation of an optical image, the lens 64 is inserted into the measurement optical path OPₘ₂ between the sample 9 and the CCD 5, and the light-shielding plate 11 is inserted into the optical path between the beam splitter 61 and the beam splitter 3.

By doing so, only the measurement light Lₘ₂′ is incident on the CCD 5. An optical image is formed by the measurement light Lₘ₂′ on the image pickup surface of the CCD 5. The optical image is captured by the CCD 5. As a result, it is possible to acquire an image of the optical image.

In the sample structure measuring device 60, it is possible to acquire an image of the first interference pattern and an image of the second interference pattern. In this case, it is possible to calculate the phase of electric field from each of the image of the first interference pattern and the image of the second interference pattern.

Phase data is obtained from the phase of electric field. This phase data is data of the wrapped phase. Therefore, it is possible to calculate the refractive index distribution of the estimation sample structure using the first calculation method.

In the sample structure measuring device 60, the first calculation method is used. As described above, in the first calculation method, the shape of the first region and the size of the first region are calculated using phase data. Therefore, it is possible to accurately measure the refractive index distribution of the sample, regardless of the size of the sample.

In the sample structure measuring device 60, the number of measurement optical paths is two. Furthermore, it is not possible to change the irradiation direction of irradiation light in each measurement optical path. In this case, images of interference patterns viewed from two directions are acquired. Thus, the shape of the first region and the size of the first region are calculated based on information obtained when the sample 9 is viewed from two directions.

As a result, it is possible to calculate the shape of the first region and the size of the first region more accurately. Furthermore, it is possible to measure the refractive index distribution of the sample more accurately, regardless of the size of the sample.

It is preferable that the sample structure measuring device of the present embodiment further include a sample rotating unit configured to rotate the sample with respect to an axis intersecting the measurement optical path, and acquire a plurality of pieces of phase data respectively corresponding to a plurality of rotation angles by changing an angle between the measurement optical path and the sample by the sample rotating unit. Moreover, the processor divides each of the plurality of pieces of phase data into phase data of a first region and phase data of a second region, estimate a predetermined region as a sample region, and the predetermined region be an overlapped region where regions where the phase data of the first region is projected in a traveling direction of the measurement light at each angle overlap when the measurement light is incident on the sample at each angle of the rotation angles.

By making such that the sample structure measuring device includes a plurality of measurement optical paths, it is possible to calculate the shape of the first region and the size of the first region more accurately. However, it is physically difficult to provide a countless number of measurement optical paths.

Then, the number of measurement optical paths is set to one, and the measurement optical path and the sample are rotated relatively. By doing so, it is possible to achieve the same effect as when a countless number of measurement optical paths are provided.

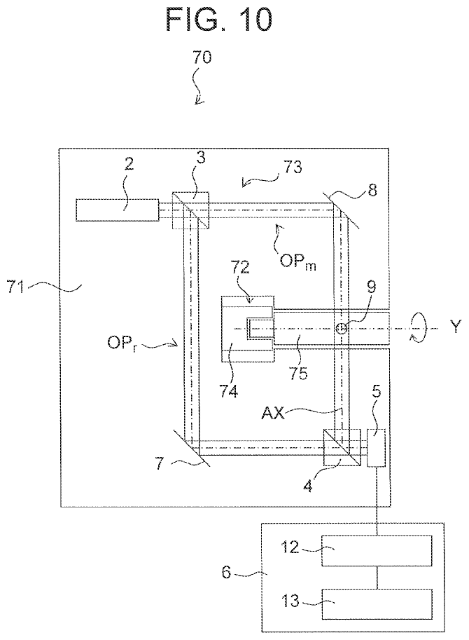

FIG. 10 is a diagram illustrating a sample structure measuring device of the present embodiment. The same configuration as that in FIG. 1 is denoted by the same numeral and a description thereof is omitted.

A sample structure measuring device 70 includes a body 71 and a sample rotating unit 72. The body 71 includes a measuring unit 73. The measuring unit 73 includes the laser 2, the beam splitter 3, the beam splitter 4, the CCD 5, the mirror 7, and the mirror 8.

The sample rotating unit 72 includes a driver 74 and a holding member 75. The sample 9 is held by the holding member 75.

In the sample rotating unit 72, the sample 9 is rotated around the axis Y. The axis Y is an axis intersecting the optical axis AX. It is possible to rotate the sample 9 and the measuring unit 73 relatively by the sample rotating unit 72.

In the sample structure measuring device 70, the measuring unit 73 is fixed, and the sample 9 rotates around the axis Y. The sample 9 is rotated whereby the sample 9 is irradiated with the measurement light Lₘ from different directions. Therefore, it is possible to increase the number of interference patterns with different irradiation directions of the measurement light Lₘ.

As a result, it is possible to calculate the shape of the first region and the size of the first region more accurately. Furthermore, it is possible to measure the refractive index distribution of the sample more accurately, regardless of the size of the sample.

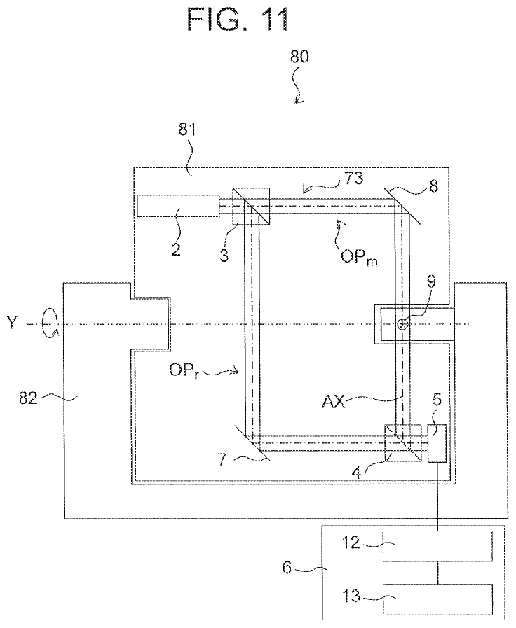

FIG. 11 is a diagram illustrating a sample structure measuring device of the present embodiment. The same configuration as that in FIG. 10 is denoted by the same numeral and a description thereof is omitted.

A sample structure measuring device 80 includes a body 81 and a body rotating unit 82. The body 81 includes the measuring unit 73. The measuring unit 73 includes the laser 2, the beam splitter 3, the beam splitter 4, the CCD 5, the mirror 7, and the mirror 8.

In the body rotating unit 82, the measuring unit 73 is rotated around the axis Y. The axis Y is the axis intersecting the optical axis AX. It is possible to rotate the sample 9 and the measuring unit 73 relatively by the body rotating unit 82.

In the sample structure measuring device 80, the sample 9 is fixed, and the measuring unit 73 rotates around the axis Y. The measuring unit 73 is rotated whereby the sample 9 is irradiated with the measurement light Lₘ from different directions. Therefore, it is possible to increase the number of interference patterns with different irradiation directions of the measurement light Lₘ.

A method of calculating the refractive index distribution will be described. It is assumed that measurement is performed using the sample structure measuring device 80.

In the sample structure measuring device 80, measurement is performed by rotating the measuring unit 73 relative to the sample 9. By performing measurement while moving the measuring unit 73, it is possible to perform measurement with different illumination angles.

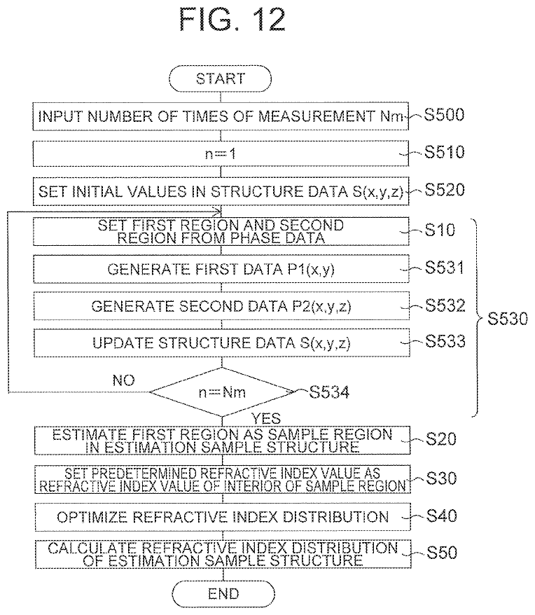

FIG. 12 is a flowchart of a second calculation method. A description of the same steps as those of the first calculation method is omitted.

In the second calculation method, images of a plurality of interference patterns are used. As described above, in the sample structure measuring device 70 and the sample structure measuring device 80, images of a plurality of interference patterns are acquired. Therefore, it is possible to use the second calculation method in the sample structure measuring device 70 and the sample structure measuring device 80.

The second calculation method includes step S500, step S510, step S520, step S530, step S20, step S30, step S40, and step S50.

At step S500, the number of times of measurement Nm is input.

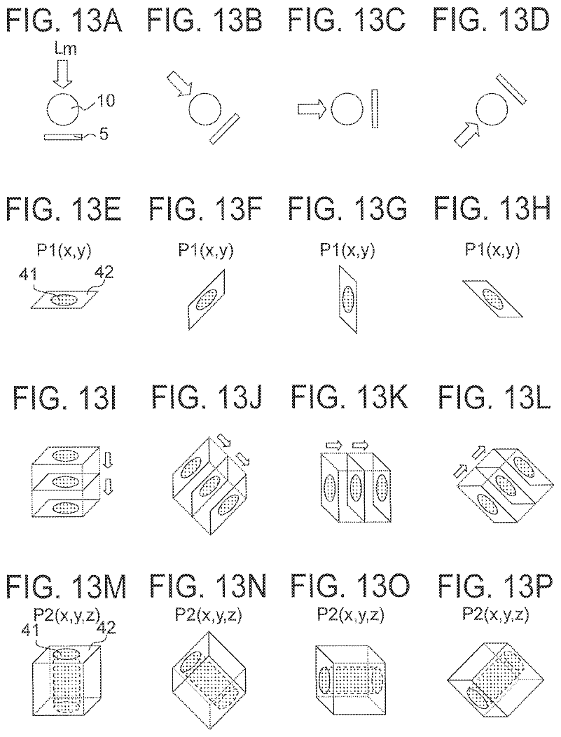

FIG. 13A, FIG. 13B, FIG. 13C, FIG. 13D, FIG. 13E, FIG. 13F, FIG. 13G, FIG. 13H, FIG. 13I, FIG. 13J, FIG. 13K, FIG. 13L, FIG. 13M, FIG. 13N, FIG. 13O, and FIG. 13P are diagrams illustrating irradiation states, planar data, appearance of projection, and solid data. FIG. 13A is a diagram illustrating a first irradiation state. FIG. 13B is a diagram illustrating a second irradiation state. FIG. 13C is a diagram illustrating a third irradiation state. FIG. 13D is a diagram illustrating a fourth irradiation state.

In the sample structure measuring device 80, the sample 9 is irradiated with the measurement light Lₘ in each irradiation state. The illumination angle varies with the states.

It is assumed that the illumination angle in the first irradiation state is 0°. The illumination angle in the second irradiation state is 45°, the illumination angle in the third irradiation state is 90°, and the illumination angle in the fourth irradiation state is 135°.

In each irradiation state, an interference pattern is formed on the light-receiving surface of the CCD 5. Since the sample 9 is a sphere, an interference pattern illustrated in FIG. 2A is formed in each irradiation state.

At step S510, 1 is set as the value of the variable n.

At step S520, initial values are set in structure data S(x,y,z).

The structure data S(x,y,z) is finally used as data representing the estimation sample structure. As described later, the structure data S(x,y,z) is updated. With updating, the structure data S(x,y,z) matches or substantially matches data of the estimation sample structure.

Since the estimation sample structure is unknown, initial values are set in the structure data S(x,y,z). For example, it is possible to use 1 as the initial values.

At step S530, the estimation sample structure is determined.

Step S530 includes step S10, step S531, step S532, step S533, and step S534.

At step S10, the first region and the second region are set from the phase data.

In each irradiation state, an interference pattern 20 is formed. As described in the first calculation method, a two-dimensional structure 40 is determined from the interference pattern 20. The two-dimensional structure 40 includes a first region 41 and a second region 42.

At step S531, first data P1(x,y) is generated.

FIG. 13E is a diagram illustrating the first data in the first irradiation state. FIG. 13F is a diagram illustrating the first data in the second irradiation state. FIG. 13G is a diagram illustrating the first data in the third irradiation state. FIG. 13H is a diagram illustrating the first data in the fourth irradiation state.

It is possible to generate the first data P1(x,y) based on the two-dimensional structure 40. In the two-dimensional structure 40, the first data P1(x,y) is obtained by setting 1 as the value of the first region 41 and setting zero as the value of the second region 42.

At step S532, second data P2(x,y,z) is generated.

FIG. 13I is a diagram illustrating the stacking direction in the first irradiation state. FIG. 13J is a diagram illustrating the stacking direction in the second irradiation state. FIG. 13K is a diagram illustrating the stacking direction in the third irradiation state. FIG. 13L is a diagram illustrating the stacking direction in the fourth irradiation state.

Since the sample 9 is a sphere, the estimation sample structure is represented by a three-dimensional structure. In order to determine the three-dimensional structure, a three-dimensional structure of the first region 41 and a three-dimensional structure of the second region 42 are necessary.

In the first data P1(x,y), the first region 41 and the second region 42 are represented by two-dimensional structures. The three-dimensional structure of the first region 41 and the three-dimensional structure of the second region 42 are obtained by stacking the first data P1(x,y) in the same direction as the irradiation direction of the measurement light Lₘ.

FIG. 13M is a diagram illustrating the second data in the first irradiation state, FIG. 13N is a diagram illustrating the second data in the second irradiation state, FIG. 13O is a diagram illustrating the second data in the third irradiation state, and FIG. 13P is a diagram illustrating the second data in the fourth irradiation state.

The second data P2(x,y,z) is obtained from the three-dimensional structure of the first region 41 and the three-dimensional structure of the second region 42.

At step S533, the structure data S(x,y,z) is updated.

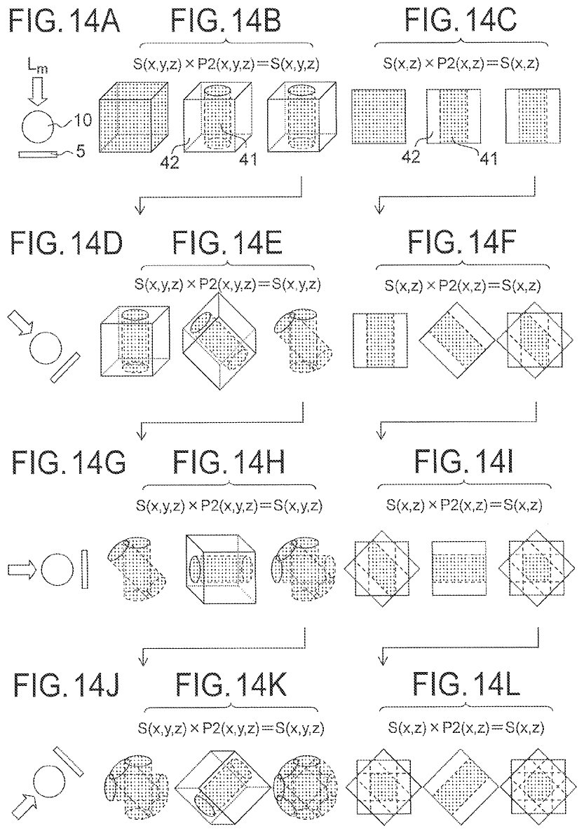

FIG. 14A, FIG. 14B, FIG. 14C, FIG. 14D, FIG. 14E, FIG. 14F, FIG. 14G, FIG. 14H, FIG. 14I, FIG. 14J, FIG. 14K, and FIG. 14L are diagrams illustrating irradiation states and updating of structure data. FIG. 14A, FIG. 14B, and FIG. 14C are diagrams illustrating the first update.

FIG. 14A is a diagram illustrating the first irradiation state. FIG. 14B is a diagram illustrating updating of the three-dimensional structure data. FIG. 14C is a diagram illustrating updating of the two-dimensional structure data.

In FIG. 14C, two-dimensional structure data is illustrated for the sake of visibility of the shape of the first region. The two-dimensional structure data indicates a cross section of the three-dimensional structure data.

The structure data S(x,y,z) is finally used as data representing the estimation sample structure. Thus, it is necessary that the structure data S(x,y,z) match or substantially match data of the estimation sample structure.

At step S520, initial values are set in the structure data S(x,y,z). Thus, the structure of the structure data S(x,y,z) with the initial values set does not match the estimation sample structure.

In the first update, the structure data S(x,y,z) with the initial values set is updated using the second data P2(x,y,z) in the first irradiation state.

The updating of the structure data S(x,y,z) is represented by the following Expression (5):

$$S ( x , y , z ) = P 2 ( x , y , z ) \times S ( x , y , z ) . \qquad ( 5 )$$

In the structure data S(x,y,z) with the initial values set, 1 is set in all of the regions. In the second data P2(x,y,z), 1 is set as the value of the first region 41, and zero is set as the value of the second region 42.

When updating is performed, a region where 1 and 1 overlap and a region where 1 and zero overlap are produced. In the structure data S(x,y,z) after updating, the region where 1 and 1 overlap is obtained as the first region.

At step S534, it is determined whether the value of the variable n matches the number of times of measurement Nm.

If the determination result is YES, step S20 is performed. If the determination result is NO, the process returns to step S530.

(If the Determination Result is YES: n=Nm)

Step S20, step S30, step S40, and step S50 are performed. The steps have been explained in the first calculation method and a description thereof is omitted here.

(If the Determination Result is NO: i≠Nx)

The process returns to step S530.

FIG. 14D, FIG. 14E, and FIG. 14F are diagrams illustrating the second update. FIG. 14D is a diagram illustrating the second irradiation state. FIG. 14E is a diagram illustrating updating of the three-dimensional structure data. FIG. 14F is a diagram illustrating updating of the two-dimensional structure data.

The structure of the structure data S(x,y,z) updated for the first time does not match the estimation sample structure. In the second update, the structure data S(x,y,z) updated for the first time is updated using the second data P2(x,y,z) in the second irradiation state.

In the structure data S(x,y,z) updated for the first time, 1 is set in a partial region. In the second data P2(x,y,z) in the second irradiation state, 1 is set as the value of the first region 41, and zero is set as the value of the second region 42.

When updating is performed, a region where 1 and 1 overlap and a region where 1 and zero overlap are produced. In the structure data S(x,y,z) after updating, the region where 1 and 1 overlap is obtained as the first region.

In FIG. 14E, the second region is not depicted in the structure data S(x,y,z), for the sake of visibility. Furthermore, since it is difficult to depict only the region where 1 and 1 overlap, the region where 1 and zero overlap is also depicted. This is applicable to FIG. 14H and FIG. 14K.

FIG. 14G, FIG. 14H, and FIG. 14I are diagrams illustrating the third update. FIG. 14G is a diagram illustrating the third irradiation state. FIG. 14H is a diagram illustrating updating of the three-dimensional structure data. FIG. 14I is a diagram illustrating updating of the two-dimensional structure data.

The structure of the structure data S(x,y,z) updated for the second time does not match the estimation sample structure. In the third update, the structure data S(x,y,z) updated for the second time is updated using the second data P2(x,y,z) in the third irradiation state.

FIG. 14J, FIG. 14K, and FIG. 14L are diagrams illustrating the fourth update. FIG. 14J is a diagram illustrating the fourth irradiation state. FIG. 14K is a diagram illustrating updating of the three-dimensional structure data. FIG. 14L is a diagram illustrating updating of the two-dimensional structure data.

The structure of the structure data S(x,y,z) updated for the third time does not match the estimation sample structure. In the fourth update, the structure data S(x,y,z) updated for the third time is updated using the second data P2(x,y,z) in the fourth irradiation state.

Since the sample 9 is a sphere, the shape of its cross section is circular. In comparison in the two-dimensional structure data, it is understood, from the structure data S(x,z) with initial values set and four updated structure data S(x,z), that the shape of the first region approaches a circle every time updating is performed.

When step S530 is finished, the first region in the estimation sample structure is determined. Therefore, at step S20, it is possible to estimate the first region as the sample region in the estimation sample structure.

When step S20 is finished, step S30, step S40, and step S50 are performed. As a result, the refractive index distribution of the estimation sample structure is calculated.

In the second calculation method, the shape of the first region and the size of the first region are calculated using phase data. This phase data is data of the wrapped phase. Therefore, it is possible to accurately measure the refractive index distribution of the sample, regardless of the size of the sample.

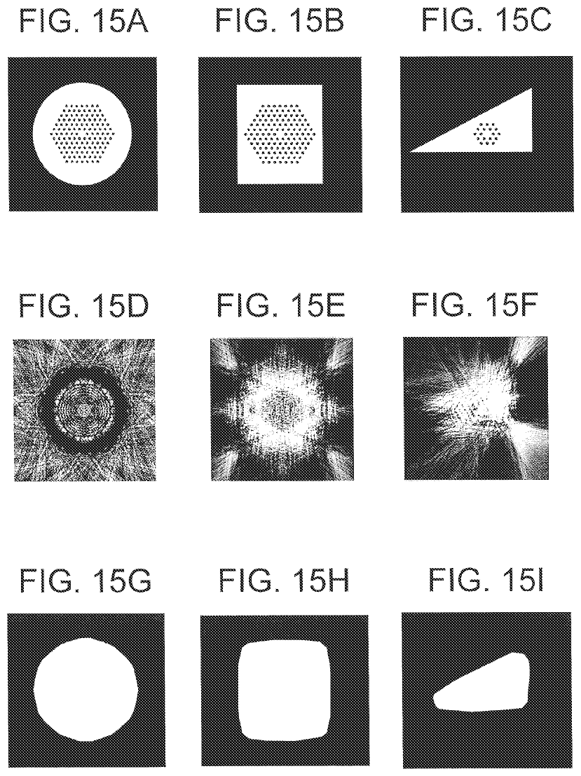

FIG. 15A, FIG. 15B, FIG. 15C, FIG. 15D, FIG. 15E, FIG. 15F, FIG. 15G, FIG. 15H, and FIG. 15I are diagrams illustrating correct shapes and shapes by simulation. FIG. 15A, FIG. 15B, and FIG. 15C are diagrams illustrating correct shapes. FIG. 15D, FIG. 15E, and FIG. 15F are diagrams illustrating the shapes calculated by Inverse Radon transform. FIG. 15G, FIG. 15H, and FIG. 15I are diagrams illustrating the shapes calculated by the second calculation method.

When the unwrapped phase is used, it is not possible to calculate the shape correctly. By comparison, in the second calculation method, data of the wrapped phase is used. Therefore, it is possible to calculate a shape close to the correct shape.

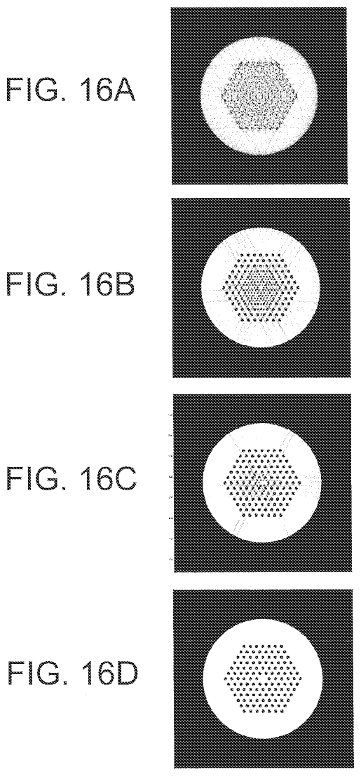

FIG. 16A, FIG. 16B, FIG. 16C, and FIG. 16D are diagrams illustrating an estimation sample structure calculated by the second calculation method. FIG. 16A is a diagram obtained when the number of times of optimization is 10. FIG. 16B is a diagram obtained when the number of times of optimization is 100. FIG. 16C is a diagram obtained when the number of times of optimization is 200. FIG. 16D is a diagram obtained when the number of times of optimization is 500.

As illustrated in FIG. 16A, FIG. 16B, FIG. 16C, and FIG. 16D, as the number of times of optimization increases, it is possible to accurately calculate the estimation sample structure.

The sample is a PCF. The outer shape of the PCF is cylindrical. As illustrated in FIG. 2A, when the sample is a sphere, an arrangement of the interference pattern changes in both of the X direction and the Y direction. By comparison, when the sample is a cylinder, the arrangement of the interference pattern changes in the X direction but does not change in the Y direction.

In this case, for example, it is possible to represent the first data in FIG. 13E by P1(x) and to represent the second data in FIG. 13M by P2(x,z). P2(x,z) is two-dimensional structure data.

For example, in FIG. 14C, updating of two-dimensional structure data is illustrated. When the sample is a cylinder, as illustrated in FIG. 14C, FIG. 14F, FIG. 14I, and FIG. 14L, the structure data only needs to be updated using S(x,z) and P2(x,z). Then, it is possible to obtain three-dimensional structure data by stacking the finally obtained structure data S(x,z) in the Y direction.

As described above, in the case of a sample in which the arrangement of the interference pattern does not change in one direction, it is possible to calculate the shape of the first region and the size of the first region using two-dimensional structure data.

In the sample structure measuring device 70 and the sample structure measuring device 80, the number of measurement optical paths is one. However, it is possible to rotate the sample 9 and the measuring unit 73 relatively. That is, it is possible to change the irradiation direction of irradiation light. In this case, images of interference patterns viewed from a plurality of directions are acquired. Thus, the shape of the first region and the size of the first region are calculated based on information obtained when the sample 9 is viewed from a plurality of directions.

As a result, no matter what shape the sample has, it is possible to calculate the shape of the first region and the size of the first region more accurately. Furthermore, it is possible to measure the refractive index distribution of the sample more accurately, regardless of the shape of the sample and the size of the sample.

In the sample structure measuring device of the present embodiment, it is preferable that the processor set a sample region based on the phase data of the first region, set a constraint region on outside of the sample region, and do not calculate the estimation sample structure of the constraint region.

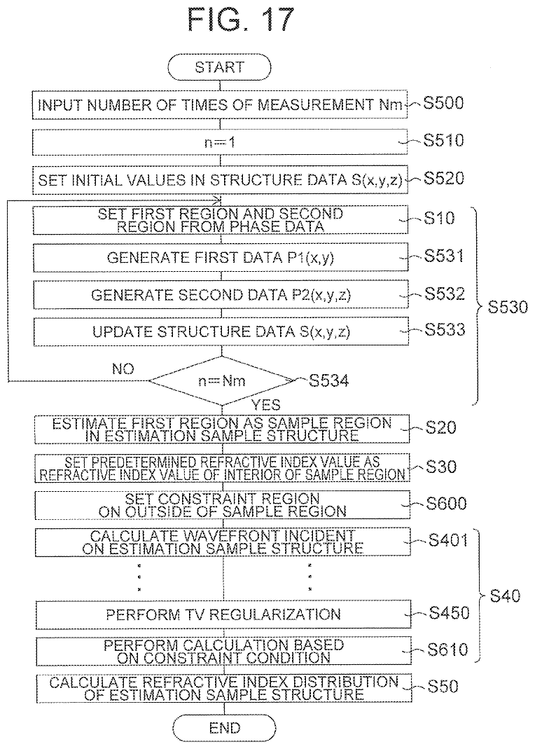

FIG. 17 is a flowchart of a third calculation method. A description of the same steps as those of the second calculation method is omitted.

In the third calculation method, a constraint region is set on the outside of the sample region. The third calculation method includes step S600 and step S610 in addition to the steps in the second calculation method.

At step S600, a constraint region is set on the outside of the sample region.

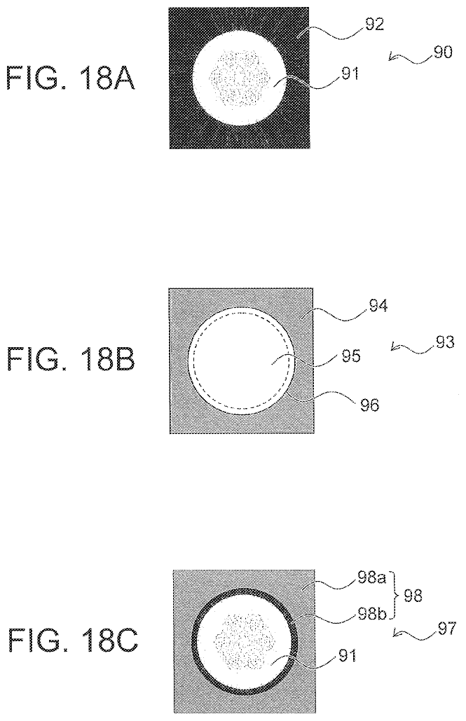

FIG. 18A, FIG. 18B, and FIG. 18C are diagrams illustrating an estimation sample structure and a constraint region. FIG. 18A is a diagram illustrating an estimation sample structure when a constraint condition is not set. FIG. 18B is a diagram illustrating a constraint region. FIG. 18C is a diagram illustrating an estimation sample structure when a constraint condition is set.

A case where the sample is a PCF will be described. It is assumed that the PCF is disposed in a homogeneous solution.

When optimization of the refractive index distribution is performed, an unnecessary refractive index distribution is calculated in some cases. The unnecessary refractive index distribution is a refractive index distribution that essentially does not exist.

As illustrated in FIG. 18A, an estimation sample structure 90 includes a sample region 91 and an outside region 92. The outside region 92 is positioned on the outside of the sample region 91. In the estimation sample structure 90, the refractive index distribution is calculated using the first calculation method or the second calculation method.

The sample region 91 is the first region and represents the PCF. The outside region 92 is the second region and represents the region filled with a solution.

In the region filled with a solution, the refractive index is the same in any place. Therefore, when the refractive index distribution is calculated, the refractive index in the second region should be the same in any place. That is, brightness essentially does not vary in the outside region 92.

However, as illustrated in FIG. 18A, in actuality, brightness varies in the outside region 92. That is, in the first calculation method and the second calculation method, an unnecessary refractive index distribution is calculated.

By setting a constraint condition, it is possible to prevent calculation of the unnecessary refractive index distribution. In the setting of a constraint condition, constraint data is used.

As illustrated in FIG. 18B, constraint data 93 includes a constraint region 94 and a non-constraint region 95. It is possible to treat the constraint data 93 as an image. In the constraint region 94, zero is set as the value of a pixel. In the non-constraint region 95, 1 is set as the value of a pixel.

In FIG. 18B, the outer edge of the sample region 91 is illustrated by a broken line. The non-constraint region 95 is set such that a boundary 96 is positioned on the outside of the sample region 91. The boundary 96 is a boundary between the constraint region 94 and the non-constraint region 95.

At step S610, calculation is performed based on the constraint condition.

It is possible to treat the estimation sample structure 90 as an image. The value of each pixel represents the value of the refractive index obtained by the second calculation method. As described above, it is also possible to treat the constraint data 93 as an image. Therefore, in the calculation based on the constraint condition, the product of the value of the estimation sample structure 90 and the value of the constraint data 93 is found for each pixel.

The result of calculation based on the constraint condition is illustrated in FIG. 18C. An estimation sample structure 97 includes the sample region 91 and an outside region 98. The outside region 98 includes a first outside region 98a and a second outside region 98b. The first outside region 98a is the same region as the constraint region 94.

In the constraint region 94, zero is set in the value. Therefore, as illustrated in FIG. 18C, in the estimation sample structure 97, the unnecessary refractive index distribution does not exist in the first outside region 98a.

It is possible to set the width of the second outside region 98b freely. It is possible to reduce a region where the unnecessary refractive index distribution is calculated, as the width of the second outside region 98b is reduced.

In the third calculation method, the unnecessary refractive index distribution is not calculated. Therefore, in the sample structure measuring device of the present embodiment, it is possible to accurately measure the refractive index distribution of the sample, regardless of the size of the sample.

In the foregoing description, the product of the value of the estimation sample structure 90 and the value of the constraint data 93 is found for each pixel. Thus, calculation for finding the product is also performed for the constraint region 94 and the first outside region 98a. However, in the constraint region 94, zero is set as the value of a pixel. Therefore, it is possible to assume that the estimation sample structure in the constraint region is not calculated.

In the sample structure measuring device of the present embodiment, it is preferable that one first region be present in one piece of phase data.

In the sample structure measuring device of the present embodiment, it is preferable that a magnifying optical system be disposed between the sample and the optical path merging portion.

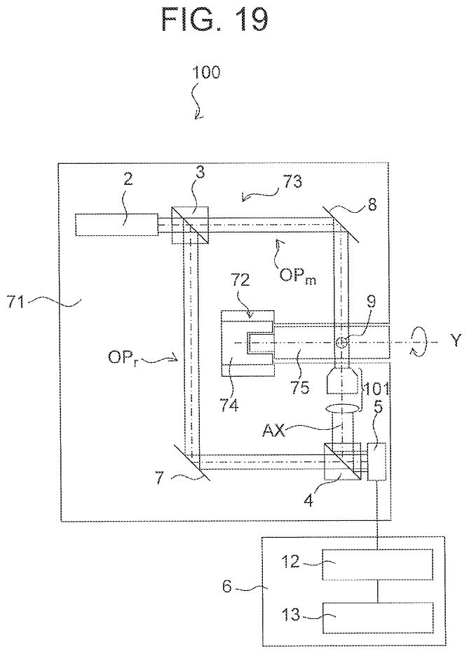

FIG. 19 is a diagram illustrating a sample structure measuring device of the present embodiment. The same configuration as that in FIG. 10 is denoted by the same numeral and a description thereof is omitted.

A sample structure measuring device 100 includes a magnifying optical system 101. The magnifying optical system 101 is disposed between the sample 9 and the beam splitter 4. The beam diameter of the measurement light is magnified by the magnifying optical system 101.

With the magnifying optical system, an interference pattern of a part of the magnified sample 9 is obtained. Therefore, it is possible to measure the refractive index distribution of the sample accurately and more finely.

In the sample structure measuring device of the present embodiment, it is preferable that the processor set a sample region based on the phase data of the first region, set a structure in which a predetermined refractive index value is set as a refractive index of interior of the sample region, as an initial structure of the estimation sample structure.

As described above, the processor 6 includes the initial structure calculating unit 12. It is possible to perform step S20 and step S30 in the initial structure calculating unit 12.

At step S10, the phase data is divided into phase data of the first region and phase data of the second region. As a result, it is possible to set the first region and the second region from the phase data.

By setting the first region, it is possible to set a sample region based on the phase data of the first region, at step S20. By setting the sample region, it is possible to set a predetermined refractive index value as the refractive index of the interior of the sample region, at step S30. As a result, it is possible to set the initial structure of the estimation sample structure.

In the sample structure measuring device of the present embodiment, it is preferable that the processor optimize the estimation sample structure using a cost function including a difference or a ratio between simulated light transmitted through the estimation sample structure and the measurement light transmitted through the sample.

As described above, the processor 6 includes the optimization unit 13. It is possible to perform step S40 in the optimization unit 13.

At step S20 and step S30, the initial structure of the estimation sample structure is set. By setting the initial structure, it is possible to optimize the estimation sample structure, at step S40. In the optimization, simulated light transmitted through the estimation sample structure (hereinafter referred to as “simulation light”) and the measurement light transmitted through the sample are used.

Furthermore, in the optimization, a cost function is used. The cost function is represented by the difference between the simulation light and the measurement light or the ratio between the simulation light and the measurement light.

In the sample structure measuring method of the present embodiment, light from a light source is split into light on a measurement optical path passing through a sample and light on a reference optical path, the light on the measurement optical path and the light on the reference optical path are merged, incident light from an optical path merging portion is detected by a photodetector having a plurality of pixels, and phase data of the incident light is output. A first region is a region where the sample is present and a second region is a region where the sample is not present. The phase data is divided into phase data of the first region and phase data of the second region, an initial structure of an estimation sample structure is set based on the phase data of the first region, and the estimation sample structure is optimized using a cost function including a difference or a ratio between simulated light transmitted through the estimation sample structure and measurement light transmitted through the sample.

According to the present disclosure, it is possible to provide a sample structure measuring device and a sample structure measuring method capable of accurately measuring a refractive index distribution of a sample, independently of the shape of the sample, the size of the sample, and the refractive index difference between the sample and the surroundings.

The present disclosure is suitable for a sample structure measuring device and a sample structure measuring method capable of accurately measuring a refractive index distribution of a sample, independently of the shape of the sample, the size of the sample, and the refractive index difference between the sample and the surroundings.

What is claimed is:

1. A sample structure measuring device comprising:
a light source;
an optical path splitting portion configured to split light from the light source into light on a measurement optical path passing through a sample and light on a reference optical path;
an optical path merging portion configured to merge light on the measurement optical path and light on the reference optical path;
a photodetector having a plurality of pixels and configured to detect incident light from the optical path merging portion and output phase data of the incident light; and
a processor,
wherein
a first region is a region where the sample is present and a second region is a region where the sample is not present, and
the processor
divides the phase data into phase data of the first region and phase data of the second region,
sets an initial structure of an estimation sample structure based on the phase data of the first region, and
optimizes the estimation sample structure using simulated light transmitted through the estimation sample structure and measurement light transmitted through the sample.

2. The sample structure measuring device according to claim 1, wherein
the phase data is divided by comparing an evaluation value with a threshold,
phase data in one row is used in calculation of the evaluation value, and
the evaluation value is calculated based on a difference between adjacent two phases.

3. The sample structure measuring device according to claim 1, wherein
the phase data is divided by comparing an evaluation value with a threshold,
phase data in one row is used in calculation of the evaluation value, and
the evaluation value is calculated based on a difference between an initial phase and another phase or a difference between a last phase and another phase.

4. The sample structure measuring device according to claim 1, further comprising a sample rotating unit configured to rotate the sample with respect to an axis intersecting the measurement optical path, and
acquire a plurality of pieces of phase data respectively corresponding to a plurality of rotation angles by changing an angle between the measurement optical path and the sample by the sample rotating unit, wherein
the processor
divides each of the plurality of pieces of phase data into phase data of a first region and phase data of a second region,
estimates a predetermined region as a sample region,
the predetermined region is an overlapped region where regions where the phase data of the first region is projected in a traveling direction of the measurement light at each angle overlap when the measurement light is incident on the sample at each angle of the rotation angles.

5. The sample structure measuring device according to claim 1, wherein the processor sets a sample region based on the phase data of the first region, sets a constraint region on outside of the sample region, and does not calculate the estimation sample structure of the constraint region.

6. The sample structure measuring device according to claim 1, wherein one first region is present in one phase data.

7. The sample structure measuring device according to claim 1, wherein the processor sets a sample region based on the phase data of the first region, sets a structure in which a predetermined refractive index value is set as a refractive index of interior of the sample region, as an initial structure of the estimation sample structure.

8. The sample structure measuring device according to claim 1, wherein the processor optimizes the estimation sample structure using a cost function including a difference or a ratio between simulated light transmitted through the estimation sample structure and the measurement light transmitted through the sample.

9. A sample structure measuring method comprising:
splitting light from a light source into light on a measurement optical path passing through a sample and light on a reference optical path;
merging the light on the measurement optical path and the light on the reference optical path; and
detecting incident light from an optical path merging portion by a photodetector having a plurality of pixels, and outputting phase data of the incident light,
wherein
a first region is a region where the sample is present and a second region is a region where the sample is not present,
the phase data is divided into phase data of the first region and phase data of the second region,
an initial structure of an estimation sample structure is set based on the phase data of the first region, and
the estimation sample structure is optimized using a cost function including a difference or a ratio between simulated light transmitted through the estimation sample structure and measurement light transmitted through the sample.
